(19) United States
(12) Patent Application Publication
(10) Pub. No.: US 2025/0220546 A1
(43) Pub. Date: Jul. 3, 2025

(54) Handling of Reference Configurations

(71) Applicant: Telefonaktiebolaget LM Ericsson (publ), Stockholm (SE)

(72) Inventors: Cecilia Eklöf, Täby (SE); Icaro Leonardo Da Silva, Solna (SE); Jens Bergqvist, Linköping (SE); Alessio Terzani, Stockholm (SE); Pontus Wallentin, Linköping (SE)

(21) Appl. No.: 18/875,334

(22) PCT Filed: Jun. 30, 2023
(86) PCT No.: PCT/SE2023/050685

§ 371 Date: Dec. 16, 2024

Related U.S. Application Data
(60) Provisional application No. 63/357,954, filed on Jul. 1, 2022.

(51) Int. Cl. H04W 36/36; H04W 36/00; H04W 76/27

(52) U.S. Cl. CPC H04W 36/362; H04W 36/00698; H04W 76/27

(57) ABSTRACT

According to some embodiments, there is provided a method performed by a user equipment, UE, the method comprising determining a reference configuration for a delta signaling of a target candidate configuration associated with a target candidate cell, and generating a full configuration version for the target candidate cell based on the determined reference configuration and the target candidate configuration.

### TECHNICAL FIELD

The disclosure relates to the handling of reference configurations.

### BACKGROUND

### 3GPP Dual Connectivity

In 3GPP Rel-12, the LTE feature Dual Connectivity (DC) was introduced, to enable the UE to be connected in two cell groups, each controlled by an LTE access node, eNBs, labelled as the Master eNB, MeNB and the Secondary eNB, SeNB. The UE still only has one RRC connection with the network. In 3GPP, the Dual Connectivity (DC) solution has since then been evolved and is now also specified for NR as well as between LTE and NR. Multi-connectivity (MC) is the case when there are more than 2 nodes involved. With introduction of 5G, the term MR-DC (Multi-Radio Dual Connectivity, see also 3GPP TS 37.340) was defined as a generic term for all dual connectivity options which includes at least one NR access node. Using the MR-DC generalized terminology, the UE is connected in a Master Cell Group (MCG), controlled by the Master Node (MN), and in a Secondary Cell Group (SCG) controlled by a Secondary Node (SN).

Further, in MR-DC, when dual connectivity is configured for the UE, within each of the two cell groups, MCG and SCG, carrier aggregation may be used as well. In this case, within the Master Cell Group, MCG, controlled by the master node (MN), the UE may use one PCell and one or more SCell(s). Within the Secondary Cell Group, SCG, controlled by the secondary node (SN), the UE may use one Primary SCell (PSCell, also known as the primary SCG cell in NR) and one or more SCell(s). This combined case is illustrated in FIG. 1. In NR, the primary cell of a master or secondary cell group is sometimes also referred to as the Special Cell (SpCell). Hence, the SpCell in the MCG is the PCell and the SpCell in the SCG is the PSCell.

There are different ways to deploy 5G network with or without interworking with LTE (also referred to as E-UTRA) and evolved packet core (EPC). In principle, NR and LTE can be deployed without any interworking, denoted by NR stand-alone (SA) operation, also known as Option 2, that is gNB in NR can be connected to 5G core network (5GC) and eNB in LTE can be connected to EPC with no interconnection between the two, also known as Option 1.

On the other hand, the first supported version of NR uses dual connectivity, denoted as EN-DC (E-UTRAN-NR Dual Connectivity), also known as Option 3, as depicted in FIG. 2. In such a deployment, dual connectivity between NR and LTE is applied, where the UE is connected with both the LTE radio interface (LTE Uu in the figure) to an LTE access node and the NR radio interface (NR Uu in the figure) to an NR access node. Further, in EN-DC, the LTE access node acts as the master node (in this case known as the Master eNB, MeNB), controlling the master cell group, MCG, and the NR access node acts as the secondary node (in this case sometimes also known as the Secondary gNB, SgNB), controlling the secondary cell group, SCG. The SgNB may not have a control plane connection to the core network (EPC) which instead is provided by the MeNB and in this case the NR. This is also called as “Non-standalone NR” or, in short, “NSA NR”. Notice that in this case the functionality of an NR cell is limited and would be used for connected mode UEs as a booster and/or diversity leg, but an RRC_IDLE UE cannot camp on these NR cells.

With introduction of 5GC, other options may be also valid. As mentioned above, option 2 supports stand-alone NR deployment where gNB is connected to 5GC. Similarly, LTE can also be connected to 5GC using option 5 (also known as eLTE, E-UTRA/5GC, or LTE/5GC and the node can be referred to as an ng-eNB). In these cases, both NR and LTE are seen as part of the NG-RAN (and both the ng-eNB and the gNB can be referred to as NG-RAN nodes).

It is worth noting that there are also other variants of dual connectivity between LTE and NR which have been standardized as part of NG-RAN connected to 5GC. Under the MR-DC umbrella, we have:
EN-DC (Option 3): LTE is the master node and NR is the secondary node (EPC CN employed, as depicted in Error! Reference source not found.)
NE-DC (Option 4): NR is the master node and LTE is the secondary (5GCN employed)
NGEN-DC (Option 7): LTE is the master node and NR is the secondary (5GCN employed)
NR-DC (variant of Option 2): Dual connectivity where both the master node, MN, controlling the MCG, and the secondary node, SN, controlling the SCG, are NR (5GCN employed, as depicted in Error! Reference source not found.).

### Conditional Handover (CHO)

In 3GPP Rel-16, the conditional handover was standardized as a solution to increase the robustness at handover. In order to avoid the undesired dependence on the serving radio link upon the time (and radio conditions) where the UE should execute the handover, the possibility to provide early RRC signaling to the UE in relation to the handover was standardized. It is possible to associate the HO command with a condition e.g. based on radio conditions possibly similar to the ones associated to an A3 event, where a given neighbour becomes X db better than the target. As soon as the condition is fulfilled, the UE executes the handover in accordance with the provided handover command.

Such a condition could e.g. be that the quality of the target cell or beam becomes X dB stronger than the serving cell. The threshold Y used in a preceding measurement reporting event should then be chosen lower than the one in the handover execution condition. This allows the serving cell to prepare the handover upon reception of an early measurement report and to provide the RRCConnectionReconfiguration with mobilityControlInfo (or the RRCReconfiguration with reconfigurationWithSync) at a time when the radio link between the source cell and the UE is still stable. The execution of the handover is done at a later point in time (and threshold), which is considered optimal for the handover execution.

FIG. 4 depicts an example with just a serving and a target cell. In practice there may often be many cells or beams that the UE reported as possible candidates based on its preceding RRM measurements. The network should then have the freedom to issue conditional handover commands for several of those candidates. The RRCConnectionReconfiguration/RRCReconfiguration message for each of those candidates may differ not just concerning the target cell but also e.g. in terms of the HO execution condition (RS to measure and threshold to exceed) as well as in terms of the RA preamble to be sent when a condition is met.

While the UE evaluates the condition, it continues operating per its current RRC configuration, i.e., without applying the conditional HO command. When the UE determines that the condition is fulfilled, it disconnects from the serving cell, applies the conditional HO command and connects to the target cell. These steps are equivalent to the legacy handover execution.

When the UE has successfully performed the random access procedure towards the target cell during a conditional handover or a normal handover, it then releases all the conditional reconfigurations that it has stored. The target cell may then configure new conditional reconfigurations to the UE if it is considered useful.

### Conditional PSCell Change (CPC) in 3GPP Rel-16

A solution for Conditional PSCell Change (CPC) procedure was also standardized in Rel-16. Therein a UE operating in Multi-Radio Dual Connectivity (MR-DC) receives in a conditional reconfiguration one or multiple RRC Reconfiguration(s) (e.g. an RRCReconfiguration message) containing an SCG configuration (e.g. a secondaryCellGroup of IE CellGroupConfig) with a reconfigurationWithSync that is stored and associated to an execution condition (e.g. a condition like an A3/A5 event configuration), so that one of the stored messages is only applied upon the fulfillment of the execution condition e.g. associated with the serving PSCell, upon which the UE would perform PSCell change (in case it finds a neighbour cell that is better than the current SpCell of the SCG). Only intra-SN CPC without MN involvement is standardized in 3GPP Rel-16, i.e. for cases where the (candidate) target PSCells are located in the current serving SN.

Similar to conditional handover, in case a random access was performed for a target PSCell and the UE was configured with CPC, the UE then releases all the conditional reconfigurations that it has stored.

### CPA and Inter-SN CPC in 3GPP Rel-17

In 3GPP Rel-17 solutions for Conditional PSCell Addition (CPA) and inter-SN CPC are being discussed and introduced. The CPA procedure is used for adding a PSCell/SCG to the configuration for a UE that is currently only configured with an MCG, when associated execution conditions are fulfilled. CPA is initiated by the MN by requesting an SCG configuration, which is to be provided as part of a conditional reconfiguration to the UE, from a (candidate) target SN (T-SN), and then sending it in a conditional reconfiguration to the UE together with the associated execution conditions.

The inter-SN CPC can be initiated either by the MN or by the source SN (S-SN), where the signaling towards the source SN and the (candidate) target SNs, as well as towards the UE, in both cases is handled by the MN. One of the possible signaling sequences for configuration of an inter-SN CPC, which is initiated by the source SN, can be seen in the signaling flow in FIG. 5.

Also for Rel-17 Conditional PSCell change (CPC)/Conditional PSCell addition (CPA), the UE configured with CPC/CPA releases the CPC/CPA configurations when completing random access towards the target PSCell.

NR-DC with Selective Activation of the Cell Groups (at Least for SCG) Via L3 Enhancements in 3GPP Rel-18

3GPP Rel-18 introduces enhancements for different mobility procedures, with a Work Item Description in RP-213565, New WI: Further NR mobility enhancements, MediaTek, 3GPP TSG RAN Meeting #94e, Dec. 6-17, 2021. One of the current objectives is “to specify mechanism and procedures of NR-DC with selective activation of the cell groups (at least for SCG) via L3 enhancements”, which includes “to allow subsequent cell group change after changing CG without reconfiguration and re-initiation of CPC/CPA”.

It should thus be possible to perform a subsequent cell group change after a first cell group change, without reconfiguring or re-initiation Conditional PSCell Change (CPC) or Conditional PSCell Addition (CPA). This would then be done in order to reduce the interruption time and the signaling overhead for SCG changes, especially in the case of frequent SCG changes when operating in FR2 in NR, compared to when these configurations are released when the UE completes random access towards the target PSCell, as in the previous releases.

### Full vs Delta Configuration

As part of mobility preparation to a target node, the source node sends the current UE configuration to the target node. The target node prepares a target configuration for the UE based on the current configuration and the target node's and the UE's capabilities. The target configuration is sent from the target node to the source node and onwards to the UE in RRCReconfiguration. As a streamlined option, the target configuration can be provided as a so called delta-configuration, indicating only the differences from the UE's current configuration in the source cell.

However, in some cases, e.g. if the target node does not recognize something in the UE's current configuration e.g. due to that the target node does not support some feature which the source node supports, the target node will trigger a full configuration. A full configuration means that the UE will clear the current configuration and make a new configuration from scratch. This is further described in section 5.3.5.11 in TS 38.331 V16.7.0 and referred to as “full configuration” or “fullConfig”. A full configuration may comprise a parameter value for each of a set of parameter types.

The full configuration may also be used at mobility if the network prefers to signal the whole UE target configuration instead of signaling a delta configuration towards the source cell, e.g if delta configuration is complex to build.

### Default Configurations

In the past, default configurations have been used in certain cases. A default configuration is a configuration where the parameters and the values of these parameters are specified, often together with an identity of the configuration. The network can only signal the identity of the configuration, and the UE will apply the values of the parameters defined for that specific default configuration. Such default configurations have e.g. been defined in RRC specifications for UTRAN, LTE and NR TS 25.331, 36.331 and 38.331 in the past.

### Retrievable Configurations

In UTRAN, retrievable configurations are defined in RRC. When the network indicates an identity of a retrievable configuration and an indication for storing, the UE stores the current values of a defined set of parameters in a UE variable. When the network indicates an identity of a retrievable configuration and an indication for revoking, the UE applies the stored values of the defined set of parameters. The retrievable configurations can also be preconfigured, i.e. explicitly signaled by the network in advance. The procedure text for retrievable configurations in TS 25.331 (Rel-17, v.17.0.0) is the following:
8.6.4.16 Retrievable configuration info
If the IE “Retrievable configuration info” is included in the reconfiguration message:
   1> perform the actions below, and then act upon all other received information elements as specified in subclause 8.6.
If the IE “Retrievable configuration to be invoked” is included in the reconfiguration message:
   1> consider the IE “Retrievable configuration to be invoked” as the invoked id;
   1> act as if all parameters stored in the variable RETRIEVABLE_CONFIGURATION for the invoked id had been received in the reconfiguration message;
   1> if any of the parameters stored in the variable RETRIEVABLE_CONFIGURATION for the invoked id are also included in the reconfiguration message or if the parameter has not been assigned a value in the variable RETRIEVABLE_CONFIGURATION:
      2> act upon the values received in the reconfiguration message for those parameters in the variable RETRIEVABLE_CONFIGURATION.
If the IE “Retrievable configuration to be stored” is included in the reconfiguration message:
   1> consider the IE “Retrievable configuration to be stored” as the stored id;
   1> after the IE “Retrievable configuration to be invoked”, if included, has been acted upon above:
      2> store the values of the parameters of the resulting configuration with the stored id in the variable RETRIEVABLE_CONFIGURATION, replacing or clearing any previously stored information in this entry.
If the IE “Retrievable configuration to be removed” is included in the reconfiguration message:
   1> remove the retrievable configurations identified by the IE “Retrievable configuration identity”.
If the IE “Retrievable configuration to be invoked” is included in the reconfiguration message and a retrievable configuration with the received identity is not stored in the variable RETRIEVABLE_CONFIGURATION:
   1> set the variable INVALID_CONFIGURATION to TRUE.
If other IEs than the IE “Preconfigured retrievable configuration” are also included in the message, the UE shall first act on those IEs, and then act on the IE “Preconfigured retrievable configuration”. For each occurrence of the IE “Preconfigured retrievable configuration”:
   1> consider the IE “Retrievable configuration identity” as the stored id;
   1> store all values of the parameters in IE “Retrievable configuration” with the stored id in the variable RETRIEVABLE_CONFIGURATION;
   1> if the same retrievable configuration identity has already been stored in the variable RETRIEVABLE_CONFIGURATION:
      2> if any of the parameters stored in the variable RETRIEVABLE_CONFIGURATION for the IE “Retrievable configuration identity” are also included in IE “Retrievable configuration” in the reconfiguration message, or if the parameter has not been assigned a value in the variable RETRIEVABLE_CONFIGURATION:
         3> overwrite the stored values with the values received in IE “Retrievable configuration” and store the new values in the variable RETRIEVABLE_CONFIGURATION.

The UE variable RETRIEVABLE_CONFIGURATION defines which parameters that the UE should store:
13.4.74 RETRIEVABLE_CONFIGURATION
The variable indicates the content of a retrievable configuration. The UE shall only store the parameters obtained via dedicated signalling into this variable. See subclause 8.6.4.16 for actions related to the setting of this variable.
This variable shall be cleared when leaving UTRA RRC connected mode and upon successful SRNS relocation.

| Information | | | Type and | Semantics | |
|---|---|---|---|---|---|
| Element/Group name | Need | Multi | reference | description | Version |
| Retrievable configuration | MP | 1 to | | | REL- |
| information | | <maxRetrievConfig> | | | 13 |
| >Retrievable configuration | MP | | Integer (0 . . . | | REL- |
| identity | | | maxRetrievConfig-1) | | 13 |
| RB Information | | | | | |
| Elements | | | | | |
| >RAB list | MP | 1 to | | | REL- |
| | | <maxRABsetup> | | | 13 |
| >>RAB identity | MP | | 10.3.1.14 | | REL- |
| | | | | | 13 |
| >>RB list | MP | 1 to | | | REL- |
| | | <maxRB | | | 13 |
| | | perRAB> | | | |
| >>>RB identity | MP | | 10.3.4.16 | | REL- |
| | | | | | 13 |
| >>>RLC info | OP | | 10.3.4.23 | | REL- |
| | | | | | 13 |
| >>>RB mapping info | OP | | 10.3.4.21 | | REL- |
| | | | | | 13 |
| >SRB list | MP | 1 to <maxSRB | | | REL- |
| | | setup> | | | 13 |
| >>RB identity | MP | | 10.3.4.16 | | REL- |
| | | | | | 13 |
| >>RLC info | OP | | 10.3.4.23 | | REL- |
| | | | | | 13 |
| >>RB mapping info | OP | | 10.3.4.21 | | REL- |
| | | | | | 13 |
| TrCH Information | | | | | |
| Elements | | | | | |
| Uplink transport | | | | | |
| channels | | | | | |
| >UL Transport channel | OP | | | Note 1. | REL- |
| information common for | | | | | 13 |
| all transport channels | | | | | |
| >>TFC subset | MD | | | | REL- |
| | | | | | 13 |
| >>>Transport Format | | | 10.3.5.22 | | REL- |
| Combination Subset | | | | | 13 |
| >>UL DCH TFCS | MP | | | | REL- |
| | | | | | 13 |
| >>>TFCS complete | MP | | 10.3.5.15 | | REL- |
| reconfiguration | | | | | 13 |
| information | | | | | |
| >>TFC subset list | OP | 1 to | | | REL- |
| | | <maxTFCsub> | | | 13 |
| >>> Transport Format | | | 10.3.5.22 | | REL- |
| Combination Subset | | | | | 13 |
| >Added or Reconfigured | OP | 1 to | | Note 1. | REL- |
| TrCH information list | | <maxTrCHpreconf> | | | 13 |
| >>Added or Reconfigured | MP | | 10.3.5.2 | | REL- |
| UL TrCH information | | | | | 13 |
| Downlink transport | | | | | |
| channels | | | | | |
| >DL Transport channel | OP | | | Note 1. | REL- |
| information common for | | | | | 13 |
| all transport channels | | | | | |
| >>DL DCH TFCS | OP | | | | REL- |
| | | | | | 13 |
| >>>TFCS complete | MP | | 10.3.5.15 | | REL- |
| reconfiguration | | | | | 13 |
| information | | | | | |
| >Added or Reconfigured | OP | 1 to | | Note 1. | REL- |
| TrCH information list | | <maxTrCHpreconf> | | | 13 |
| >>Added or Reconfigured | MP | | 10.3.5.1 | Note 2. | REL- |
| DL TrCH information | | | | | 13 |
| PhyCH information | | | | | |
| elements | | | | | |
| >DTX-DRX Information | OP | | DTX- | Note 1. | REL- |
| | | | DRX | | 13 |
| | | | Information | | |
| | | | 10.3.6.34a | | |
| >HS-SCCH less | OP | | HS-SCCH | Note 1. Note 3. | REL- |
| | | | less | | |
| | | | Information | | |
| Information | | | 10.3.6.36ab | | 13 |
| >MIMO parameters | OP | | MIMO | Note 1. Note 3. | REL- |
| | | | parameters | | 13 |
| | | | 10.3.6.41a | | |
| >MIMO mode with four | OP | | MIMO | Note 1. Note 3. | REL- |
| transmit antennas | | | mode with | | 13 |
| parameters | | | four | | |
| | | | transmit | | |
| | | | antennas | | |
| | | | parameters | | |
| | | | 10.3.6.142 | | |
| >DCH Enhancements info | OP | | DCH | Note 1. Note 3. | REL- |
| | | | Enhancements | | |
| | | | info FDD | | |
| FDD | | | 10.3.6.149 | | 13 |
| Uplink radio resources | | | | | |
| >E-DCH Info | OP | | E-DCH | Note 1. Note 4. | REL- |
| | | | Info | | 13 |
| | | | 10.3.6.97 | | |
| Downlink radio | | | | | |
| resources | | | | | |
| >Downlink HS-PDSCH | OP | | Downlink | Note 1. | REL- |
| Information | | | HS- | | 13 |
| | | | PDSCH | | |
| | | | Information | | |
| | | | 10.3.6.23a | | |
| >Downlink secondary cell | OP | | Downlink | Note 1. Note 3. | REL- |
| info FDD | | | secondary | | 13 |
| | | | cell info | | |
| | | | FDD | | |
| | | | 10.3.6.31a | | |
| >Additional downlink | OP | 2 | | Note 1. | REL- |
| secondary cell info list | | | | | 13 |
| FDD | | | | | |
| >>Downlink secondary | OP | | Downlink | Note 1. Note 3. | REL- |
| cell info FDD | | | secondary | | 13 |
| | | | cell info | | |
| | | | FDD | | |
| | | | 10.3.6.31a | | |
| >Additional downlink | OP | 4 | | Note 1. | REL- |
| secondary cell info list | | | | | 13 |
| FDD 2 | | | | | |
| >>Downlink secondary | OP | | Downlink | Note 1. Note 3. | REL- |
| cell info FDD | | | secondary | | 13 |
| | | | cell info | | |
| | | | FDD | | |
| | | | 10.3.6.31a | | |

NOTE 1:
Void.
NOTE 2:
The IE “MAC-hs queue to delete list” shall not be stored as part of RETRIEVABLE CONFIGURATION.
NOTE 3:
Only values for “New configuration” or “New operation” or “start” shall be stored.
NOTE 4:
The IE “MAC-es/e reset indicator” shall not be stored as part of RETRIEVABLE_CONFIGURATION.

### SUMMARY

There currently exist certain challenge(s). In rel-16 and rel-17, conditional reconfigurations (e.g. CHO, CPC, CPA) are released by the UE upon execution of any conditional reconfiguration (upon fulfillment of the execution condition monitored by the UE) or upon execution of reconfigurationWithSync, i.e. at handover or PSCell change (upon reception of the handover command). This is a simple solution, but one problem is that after the UE is in the new cell (e.g. after PSCell execution) the network may want to configure the UE again with new CPC candidates, and may end up configuring cells which have been previously configured and whose configurations have been deleted.

In rel-18 the conditional reconfigurations (i.e. the target candidate configuration(s), denoted RRCReconfiguration*(k) for the k-th candidate, to be applied upon fulfillment of the execution conditions) should not always be deleted upon execution of CHO/CPC/CPA and/or reconfiguration with sync anymore; hence, the CPC/CHO/CPA configurations of target candidates (e.g. RRCReconfiguration*(1), . . . , RRCReconfiguration*(K)) are not deleted when the UE moves from one cell to another, and may be later applied, after the UE has moved to another cell. The solution in which the UE keeps the configurations of target candidates stored during reconfiguration with sync and/or conditional reconfiguration execution reduces the signaling and improves potentially improves reliability, but one problem emerges: the so-called the delta problem (the delta problem refers to the “delta signaling”, which comprises a set of parameter types to be modified in a given configuration, while the parameters type in which the UE knows is part of the message structure but are absent when the message is received, indicates to the UE that the shall keep using the values of the same parameter type in the UE's current configuration (for further details see Need Code M in 3GPP TS 38.331 (Rel-17, v.17.0.0)).

The delta problem emerges because a target candidate node (such as a target candidate SN in the case of CPC) receives a request to configure a UE with conditional reconfiguration (such as CPC, with the request being an SN Addition Request message over Xn from the MN to the SN), wherein the request includes the UE's current SCG configuration (e.g. the RRC parameters, fields, IEs). It is based on that UE's current SCG configuration that the target candidate node generates the SCG's target candidate configuration to be applied upon the fulfilment of the execution condition (which is a delta signaling having the UE's current SCG configuration as reference i.e. only parameters to be modified are added, absent parameters means the UE uses current ones). That delta signaling is the SCG's target candidate configuration provided to the UE. If the UE executes CPC or a reconfiguration with sync a first time there is no problem: the UE applies the SCG's target candidate configuration (delta signaling) on top of the UE's current SCG configuration, and the SCG's target candidate configuration (delta signaling) has been generated having the UE's current SCG configuration as reference for the delta signaling. However, after the UE is in the new cell, and tries to apply one of the stored target candidate configuration(s) e.g. upon fulfilment of execution conditions, a reconfiguration failure may occur, as the stored target candidate configuration(s) the UE would apply have been designed as a delta signaling having the UE's previous SCG configuration as reference, not the UE's current SCG configuration (after the first execution).

An example of how the delta configuration problem (or simply delta problem) can occur is shown in FIG. 6. The UE is configured with CPC for target candidate cell B (i.e. UE has stored an RRCReconfiguration(B)) and for candidate cell C (i.e. UE has stored an RRCReconfiguration(C)) when it is in cell A (i.e. UE's current configuration is equivalent to RRCReconfiguration(A)).
When the target candidate SN of Cell B was requested to configure CPC, it has generated the RRCReconfiguration(B) as a delta signaling having as reference RRCReconfiguration(A) i.e. the parameters which the target candidate SN wanted to remain the same as in RRCReconfiguration(A) were left absent in the generated RRCReconfiguration(B) message.
When the target candidate SN of Cell C was requested to configure CPC, it has generated the RRCReconfiguration(A) as a delta signaling having as reference RRCReconfiguration(A) i.e. the parameters which the target candidate SN wanted to remain the same as in RRCReconfiguration(A) were left absent in the generated RRCReconfiguration(C) message.

While in cell A, the UE determines that executions conditions have been fulfilled for cell B and selects that cell i.e. the UE executes CPC to cell B by applying the RRCReconfiguration(B), and keeps the CPC configuration for cell C stored (RRCReconfiguration(C)). The configuration for cell C is a delta configuration (or delta signaling) generated by the target candidate SN (e.g. a gNodeB operating as SN) responsible for cell C, having the UE's current configuration at the time of the configuration as the reference for the delta (i.e. RRCReconfiguration(A)). However, if the UE keeps the RRCReconfiguration(C) stored when in cell B, and the CPC execution conditions for cell C are fulfilled while in cell B, this delta configuration is then applied when in cell B. The final configuration will then not be correct as the source configuration which the delta is applied towards is not the intended source configuration. This may lead to an RRC Reconfiguration failure which may trigger a SCG failure report, instead of a successful CPC execution.

The problem will be even more complex if the UE executes multiple CPCs one after another, as it is then unclear which configuration that the delta is indicated towards. The network does not know in advance, i.e. when the conditional reconfigurations are signaled to the UE, in which order the conditional reconfigurations will be executed and hence cannot know which would be the current configuration of the UE when the conditional reconfiguration is applied.

Certain aspects of the disclosure and their embodiments may provide solutions to these or other challenges.

The examples herein include different methods for a UE to determine a reference configuration (e.g. by receiving indications of the reference configuration(s), or by selecting), to store the reference configuration(s) and to use the reference configuration(s) when applying a delta configuration on top of the source configuration.

The examples herein also include a solution where the UE generates a full configuration for each delta configuration based on the reference configuration, when it is configured with the candidate configurations, and stores the full configuration for each candidate cell.

The examples herein also include different methods for a network node, e.g. a node acting as a Master Node (MN), to determine a reference configuration and to signal a reference configuration or an indication of a reference configuration or an indication of how to generate a reference configuration to a UE.

The examples herein also include includes methods for network nodes, e.g. nodes acting as Master Node (MN) or Secondary Node (SN) to signal a reference configuration or an indication of a reference configuration or an indication of how to generate a reference configuration between network nodes such as between an MN and an SN.

The following describes a method according to an example of the disclosure.

A1. A Method at a User Equipment (UE) operating in Multi-Radio Dual Connectivity (MR-DC) and connected at least to a Master Node (MN) and having a UE's current SCG configuration, the method comprising:
Receiving an RRC Reconfiguration message from the MN comprising one or more target candidate configuration(s), each associated to a target candidate cell of conditional reconfiguration;
wherein at least one of target candidate configuration(s) comprises a delta signaling;
the method further comprising the UE determining a reference configuration for the delta signaling of the at least one target candidate configuration(s); and
upon fulfillment of an execution condition for one of the target candidate cells of conditional reconfiguration, selecting one of the cells for which the execution conditions is fulfilled; and
applying the target candidate configuration(s) of the selected cell to the determined reference configuration.

A2. A method according to A1, further comprising the UE determining the reference configuration for the delta signaling of the at least one target candidate configuration(s) to be the UE's SCG configuration at the time the UE has received the RRC Reconfiguration message from the MN.

A3. A method according to A1, further comprising the UE determining the reference configuration for the delta signaling of the at least one target candidate configuration(s) to be a default configuration the UE has in its memory.

A4. A method according to A1, further comprising the UE determining the reference configuration for the delta signaling of the at least one target candidate configuration(s) to be a configuration included in the RRC Reconfiguration message, and indicated to be the reference configuration.

A5. A method according to A1, wherein the determined reference configuration is stored, and before applying the target candidate configuration of the selected cell, reverting the UE's SCG configuration to the reference configuration, then applying the target candidate configuration of the selected cell.

A6. A method according to A1, generating a full configuration version for at least a target candidate configuration based on the determined reference configuration, and storing the full configuration version.

A6b. A method according to A6, upon selecting the cell, applying the generated full configuration version associated to the target candidate configuration.

A7. A method according to A6, further comprising releasing the reference configuration when the full configuration version is generated.

Certain embodiments may provide one or more of the following technical advantage(s). The advantage of the solution is that it makes it clear towards which configuration the UE should apply a delta configuration. This also decreases the amount of signaling, as delta configurations can be used in more cases and full configurations do not have to be used in cases where multiple conditional reconfigurations are stored and not deleted upon execution of other conditional reconfigurations or reconfigurationWithSync.

According to an aspect of the disclosure, there is provided a method performed by a user equipment, UE. The method comprises determining a reference configuration for a delta signaling of a target candidate configuration associated with a target candidate cell. The method further comprises generating a full configuration version for the target candidate cell based on the determined reference configuration and the target candidate configuration.

According to a further aspect of the disclosure, there is provided a method performed by a network node. The method comprises signaling to a UE or a network node at least one of a reference configuration for a delta signaling of a target candidate configuration associated with a target candidate cell, an indication of a reference configuration for a delta signaling of a target candidate configuration associated with a target candidate cell, and an indication of how to generate a reference configuration for a delta signaling of a target candidate configuration associated with a target candidate cell. The target candidate configuration and the reference configuration can be used by the UE to generate a full configuration version for the target candidate cell.

According to a further aspect of the disclosure, there is provided a user equipment for reconfiguration in a network. The user equipment comprises processing circuitry configured to cause the user equipment to determine a reference configuration for a delta signaling of a target candidate configuration associated with a target candidate cell. The processing circuitry is further configured to cause the user equipment to generate a full configuration version for the target candidate cell based on the determined reference configuration and the target candidate configuration. The user equipment further comprises power supply circuitry configured to supply power to the processing circuitry.

According to a further aspect of the disclosure, there is provided a user equipment for reconfiguration in a network, the user equipment configured to determine a reference configuration for a delta signaling of a target candidate configuration associated with a target candidate cell. The user equipment is further configured to generate a full configuration version for the target candidate cell based on the determined reference configuration and the target candidate configuration.

According to a further aspect of the disclosure, there is provided a network node for reconfiguration in a network. The network node comprises processing circuitry configured to cause the network node to signal to a UE or a network node at least one of a reference configuration for a delta signaling of a target candidate configuration associated with a target candidate cell, an indication of a reference configuration for a delta signaling of a target candidate configuration associated with a target candidate cell, and an indication of how to generate a reference configuration for a delta signaling of a target candidate configuration associated with a target candidate cell. The target candidate configuration and the reference configuration can be used by the UE to generate a full configuration version for the target candidate cell. The network node further comprises power supply circuitry configured to supply power to the processing circuitry.

According to a further aspect of the disclosure, there is provided a network node for reconfiguration in a network. The network node is configured to signal to a UE or a network node at least one of a reference configuration for a delta signaling of a target candidate configuration associated with a target candidate cell, an indication of a reference configuration for a delta signaling of a target candidate configuration associated with a target candidate cell, and an indication of how to generate a reference configuration for a delta signaling of a target candidate configuration associated with a target candidate cell. The target candidate configuration and the reference configuration can be used by the UE to generate a full configuration version for the target candidate cell.

### BRIEF DESCRIPTION OF THE DRAWINGS

For a better understanding of the embodiments of the present disclosure, and to show how it may be put into effect, reference will now be made, by way of example only, to the accompanying drawings, in which:

FIG. 1 illustrates dual connectivity combined with carrier aggregation in MR-DC;

FIG. 2 illustrates EN-DC;

FIG. 3 illustrates NR-DC;

FIG. 4 illustrates conditional handover execution;

FIG. 5 illustrates Inter-SN CPC in 3GPP Rel-17;

FIG. 6 illustrates delta configuration problem when conditional reconfigurations are maintained;

FIG. 7 illustrates a method in a UE according to an example;

FIG. 8 illustrates a method in a network node according to an example;

FIG. 9 illustrates a method in a network node according to an example;

FIG. 10 illustrates a method in a network node according to an example;

FIG. 11 illustrates a method in a network node according to an example;

FIG. 12 illustrates handling of reference configurations;

FIG. 13 illustrates a communication system according to an example;

FIG. 14 illustrates a UE according to an example;

FIG. 15 illustrates a network node according to an example;

FIG. 16 illustrates a host according to an example;

FIG. 17 illustrates a virtualization environment according to an example; and

FIG. 18 illustrates a communication network according to an example.

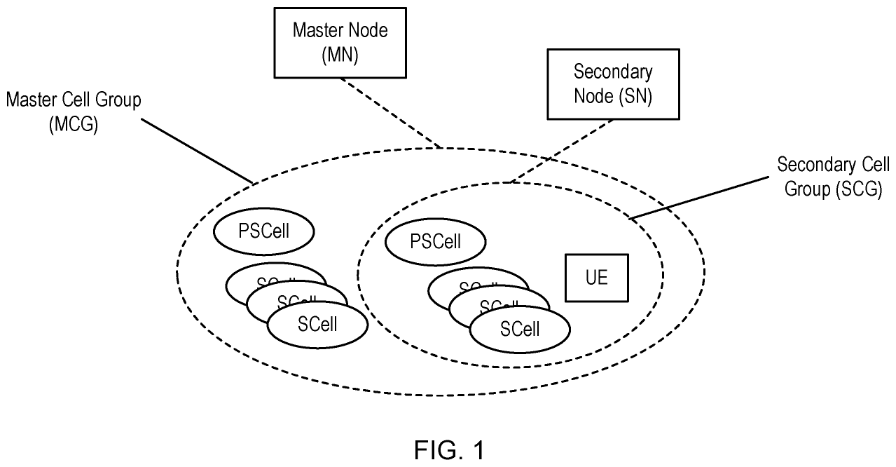

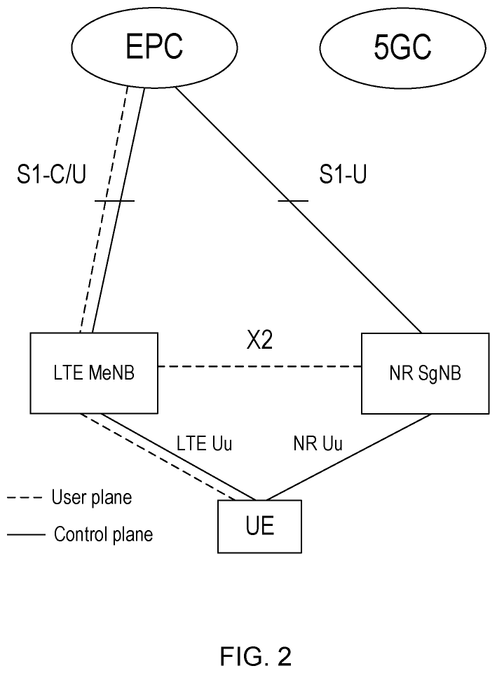

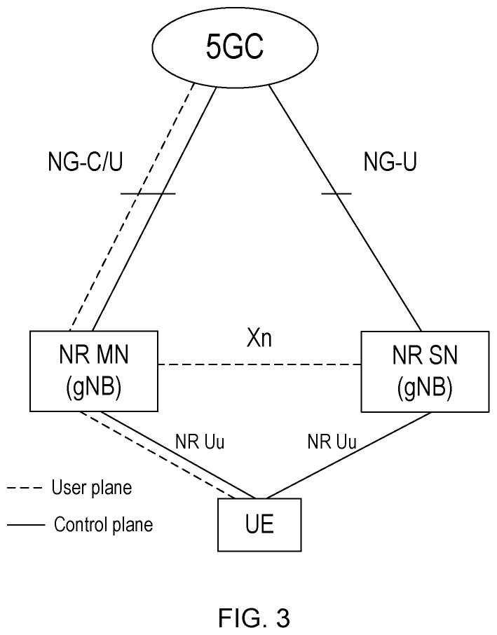

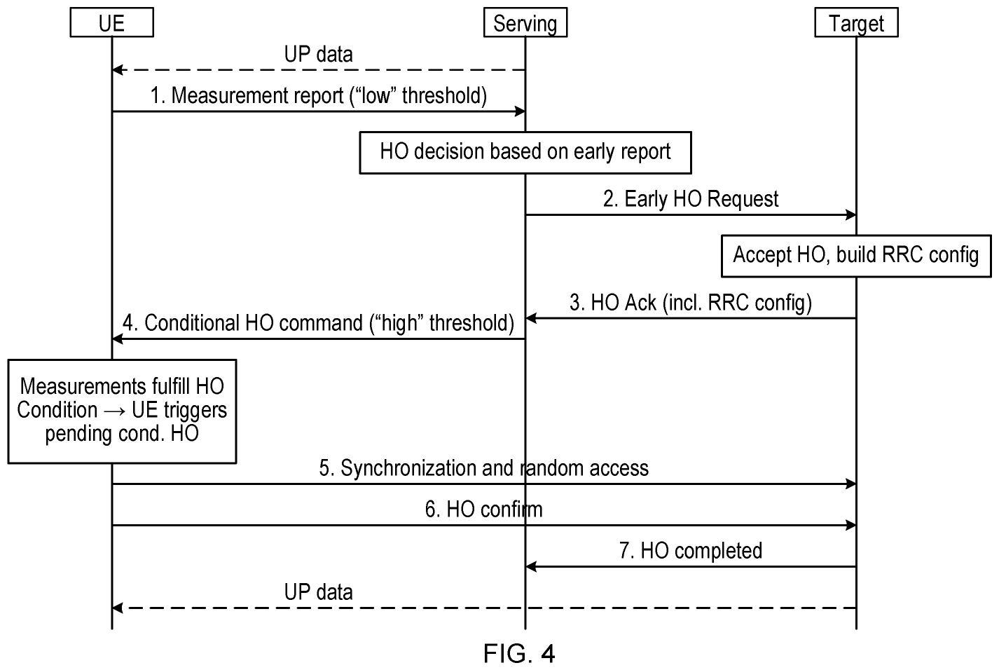

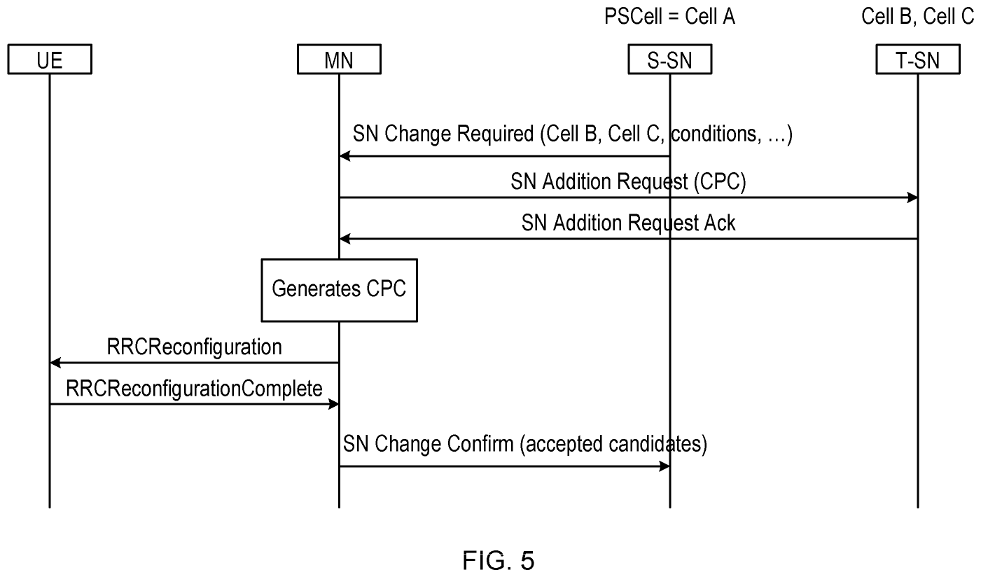

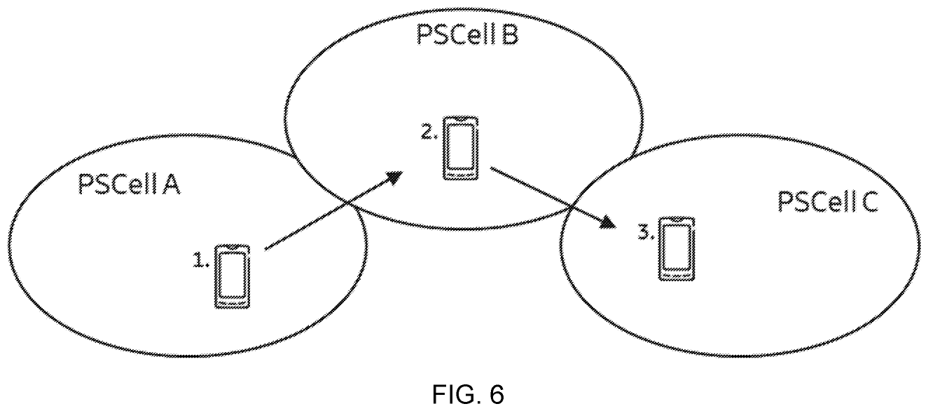

### DETAILED DESCRIPTION

Some of the embodiments contemplated herein will now be described more fully with reference to the accompanying drawings. Embodiments are provided by way of example to convey the scope of the subject matter to those skilled in the art.

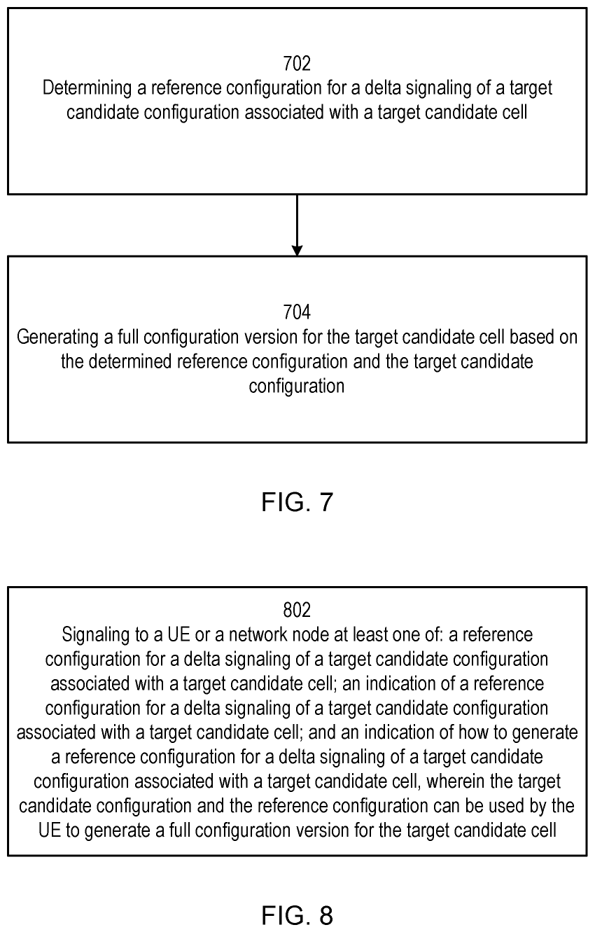

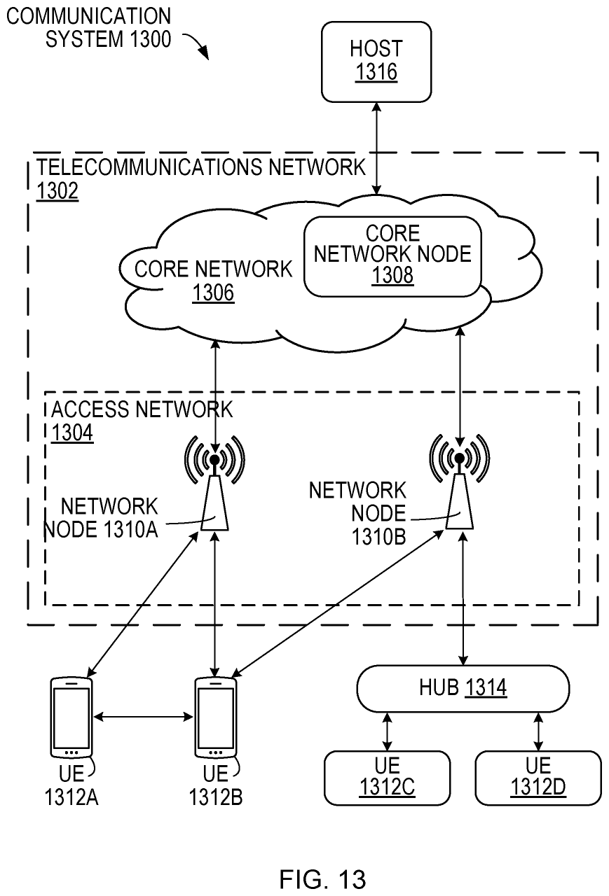

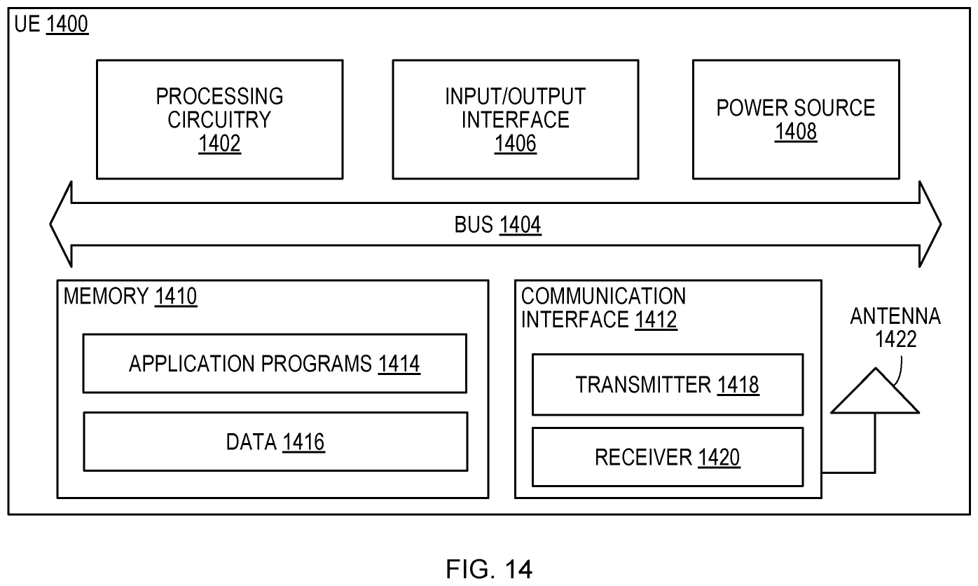

FIG. 7 depicts a method in accordance with particular embodiments. The method 7 may be performed by a UE or wireless device (e.g. the UE 1312 or UE 1400 as described later with reference to FIGS. 13 and 14 respectively). The method begins at step 702 with determining a reference configuration for a delta signaling of a target candidate configuration associated with a target candidate cell. The method continues at step 704 with generating a full configuration version for the target candidate cell based on the determined reference configuration and the target candidate configuration. For example, the step may comprise determining a reference configuration for a target candidate configuration associated with a target candidate cell. The target candidate cell may be a target candidate cell of conditional reconfiguration. The reference configuration may be the reference configuration for delta signaling of the target candidate configuration. The method may further comprise storing the current configuration of the UE as the reference configuration. The method may further comprise receiving an indication to store the current configuration of the UE as the reference configuration. The indication may be received along with instructions for reconfiguration, and wherein the indication may indicate that the configuration to be stored is the configuration of the UE before applying the instructions or the configuration of the UE after applying the instructions. The method may further comprise applying the target candidate configuration to the determined reference configuration. The method may further comprise, before applying the target candidate configuration, reverting the UE's configuration to the reference configuration if the UE's configuration is not the reference condition, then applying the target candidate configuration. The method may further comprise receiving from a network node information comprising at least one of: a reference configuration; an indication of a reference configuration; an indication of how to generate a reference configuration; an indication of which configuration amongst a UE source configuration or at least one UE target candidate configuration is the reference configuration; an indication that the current UE configuration can be used as the reference configuration.

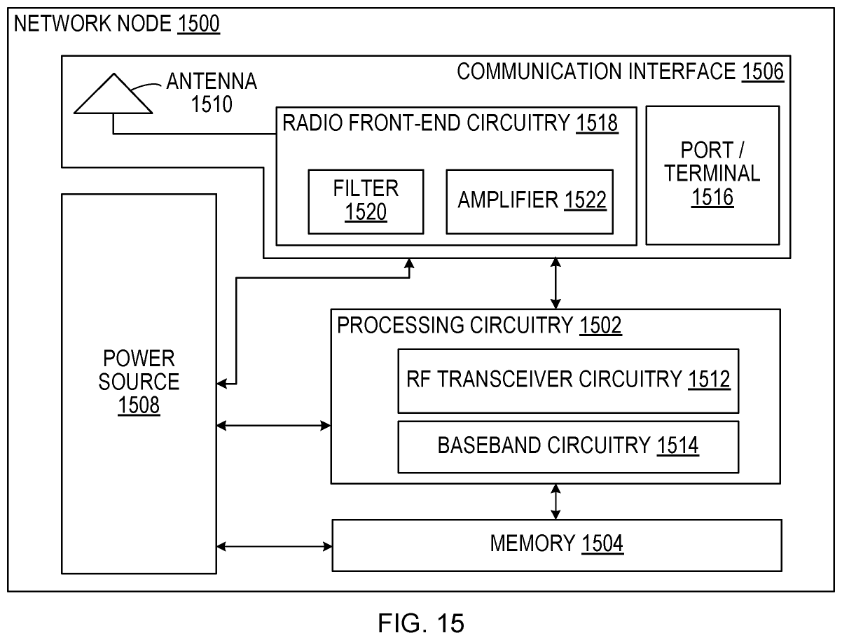

FIG. 8 depicts a method in accordance with particular embodiments. The method 8 may be performed by a network node (e.g. the network node 1310 or network node 1500 as described later with reference to FIGS. 13 and 15 respectively). The method begins at step 802 with signaling to a UE or a network node at least one of: a reference configuration for a delta signaling of a target candidate configuration associated with a target candidate cell; an indication of a reference configuration for a delta signaling of a target candidate configuration associated with a target candidate cell; an indication of how to generate a reference configuration for a delta signaling of a target candidate configuration associated with a target candidate cell, wherein the target candidate configuration and the reference configuration can be used by the UE to generate a full configuration version for the target candidate cell. For example, the method may comprise signaling to a UE or a network node at least one of: a reference configuration for a target candidate configuration associated with a target candidate cell; an indication of a reference configuration for a target candidate configuration associated with a target candidate cell; an indication of how to generate a reference configuration for a target candidate configuration associated with a target candidate cell. The method may further comprise determining the reference configuration.

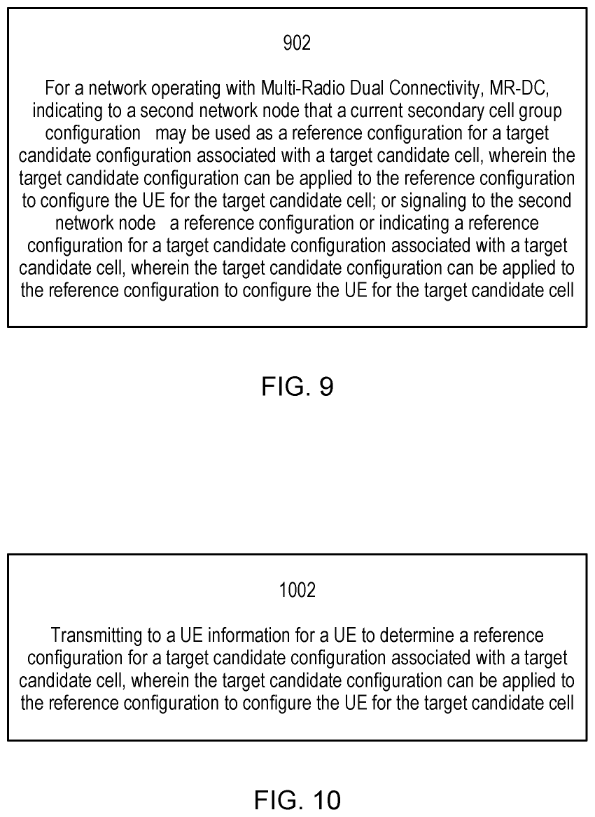

FIG. 9 depicts a method in accordance with particular embodiments. The method 9 may be performed by a network node (a first network node) (e.g. the network node 1310 or network node 1500 as described later with reference to FIGS. 13 and 15 respectively). The method begins at step 902 with, for a network operating with Multi-Radio Dual Connectivity, MR-DC, indicating to a second network node that a current secondary cell group configuration may be used as a reference configuration for a target candidate configuration associated with a target candidate cell, wherein the target candidate configuration can be applied to the reference configuration to configure the UE for the target candidate cell; or signaling to the second network node a reference configuration or indicating a reference configuration for a target candidate configuration associated with a target candidate cell, wherein the target candidate configuration can be applied to the reference configuration to configure the UE for the target candidate cell. For example, the method may comprise indicating to a second network node that a current secondary cell group configuration may be used as a reference configuration for a target candidate configuration associated with a target candidate cell; and/or signaling to the second network node a reference configuration or indicating a reference configuration for a target candidate configuration associated with a target candidate cell. The method may further comprise determining that a conditional cell change is to be configured; and transmitting to the second network node a request for conditional cell change, comprising conditional cell change candidates and current secondary cell group configuration. The first network node may be a source secondary node, S-SN. The second network node may be a master node.

FIG. 10 depicts a method in accordance with particular embodiments. The method 10 may be performed by a network node (a second network node) (e.g. the network node 1310 or network node 1500 as described later with reference to FIGS. 13 and 15 respectively). The method begins at step 1002 with transmitting to a UE information for a UE to determine a reference configuration for a target candidate configuration associated with a target candidate cell, wherein the target candidate configuration can be applied to the reference configuration to configure the UE for the target candidate cell. For example, the method may comprise transmitting to a UE information for a UE to determine a reference configuration for a target candidate configuration associated with a target candidate cell. The second network node may be a master node. The information may be comprised in a reconfiguration message. The method may further comprise, prior to the transmitting, receiving from a third network node at least one of: a target secondary cell group configuration; a reference configuration for a target candidate configuration associated with a target candidate cell; an indication of a reference configuration for a target candidate configuration associated with a target candidate cell. The method may further comprise receiving a request for conditional cell change, comprising conditional cell change candidates and current conditional cell change confirmation; transmitting, to a third network node, a request message for conditional cell change, the message comprising the conditional cell change candidate and the current conditional cell change configuration; or transmitting, to the third network node, a reference configuration or the current secondary cell group configuration and the reference configurations. The third network node may comprise a target candidate secondary node.

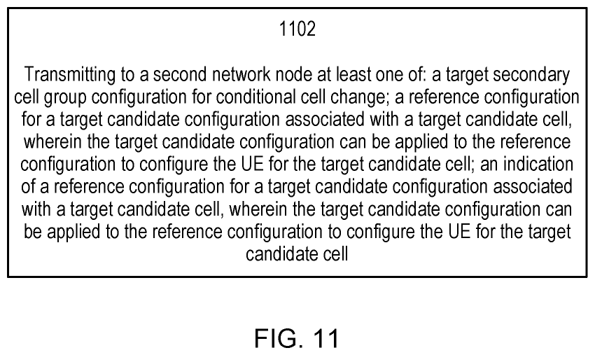

FIG. 11 depicts a method in accordance with particular embodiments. The method 11 may be performed by a network node (a third network node) (e.g. the network node 1310 or network node 1500 as described later with reference to FIGS. 13 and 15 respectively). The method begins at step 1102 with transmitting to a second network node at least one of: a target secondary cell group configuration for conditional cell change; a reference configuration for a target candidate configuration associated with a target candidate cell, wherein the target candidate configuration can be applied to the reference configuration to configure the UE for the target candidate cell; an indication of a reference configuration for a target candidate configuration associated with a target candidate cell, wherein the target candidate configuration can be applied to the reference configuration to configure the UE for the target candidate cell. For example, the method may comprise transmitting to a second network node at least one of: a target secondary cell group configuration for conditional cell change; a reference configuration for a target candidate configuration associated with a target candidate cell; an indication of a reference configuration for a target candidate configuration associated with a target candidate cell. The method may further comprise, prior to the transmitting, receiving, from the second network node, a request message for conditional cell change, the message comprising at least one of: the conditional cell change candidates and the current secondary cell group configuration; a reference configuration, or the current secondary cell group configuration and the reference configuration. The method may further comprise receiving from the second network node a message containing information that the UE has executed conditional cell change and for which cell the UE has executed the conditional cell change.

### Initial Disclaimers

The examples herein refer to a first network node operating as a Master Node (MN), e.g. having a Master Cell Group (MCG) configured to the UE; that MN can be a gNodeB, or a Central Unit gNodeB (CU-gNB) or an eNodeB, or a Central Unit eNodeB (CU-eNB), or any network node and/or network function. The examples herein also refer to a second network node operating as a Secondary Node (SN), or Source Secondary Node (S-SN) e.g. having a Secondary Cell Group (SCG) pre-configured (i.e. not connected to) to the UE; that SN can be a gNodeB, or a Central Unit gNodeB (CU-gNB) or an eNodeB, or a Central Unit eNodeB (CU-eNB), or any network node and/or network function. Notice that MN, S-SN and T-SN may be from the same or different Radio Access Technologies (and possibly be associated to different Core Network nodes).

The text often refers to a “Secondary Node (SN)”, or target SN. This is equivalent to say this is a target candidate SN, or a network node associated to a target candidate PSCell that is being configured. If the UE connects to that cell, transmissions and receptions with the UE would be handled by that node if the cell is associated to that node.

The text says that a cell resides in a node e.g. a target candidate cell resides in the S-SN or the t-SN. This is equivalent to saying that a cell is managed by the node, or is associated to the node, or associated with the node, or that the cell belongs to the node, or that the cell is of the node.

“SN-initiated CPC” corresponds to a procedure wherein the Source SN for a UE configured with MR-DC determines the CPC is to be configured. Upon determining the Source SN selects e.g. based on reported measurements, one or more target candidate cells (target candidate PSCell(s)) wherein at least one cell is associated to the Source SN, and at least another cell is associated to a neighbour SN. It can be said that, if all target candidate cells are associated to the Source SN, then the CPC is an “SN-initiated intra-SN CPC”. It can be said that, if at least one target candidate cell is associated to a neighbour SN, then the CPC is an “SN-initiated inter-SN CPC”.

This disclosure refers to a candidate SN, or SN candidate, or an SN, as the network node (e.g. gNodeB) that is prepared during the CPA procedure and that can create an RRC Reconfiguration message with an SCG configuration (e.g. RRCReconfiguration**) to be provided to the UE and stored, with an execution condition, wherein the UE only applies the message upon the fulfillment of the execution condition. That candidate SN is associated to one or multiple PSCell candidate cell(s) that the UE can be configured with. The UE then can execute the condition and accesses one of these candidate cells, associated to a candidate SN that becomes the SN or simply the SN after execution (i.e. upon fulfillment of the execution condition).

This disclosure refers to a Conditional PSCell Change (CPC) configuration and procedures (like CPC execution), most of the time to refer to the procedure from the UE perspective. Other terms may be considered as synonyms such as conditional reconfiguration, or Conditional Configuration (since the message that is stored and applied upon fulfillment of a condition is an RRCReconfiguration or RRCConnectionReconfiguration). Terminology wise, one could also interpret conditional handover (CHO) in a broader sense, also covering CPA (Conditional PSCell Change) procedures. The document refers to a Conditional SN Change generally to refer to the procedure from the UE perspective, to refer to procedures between network nodes wherein a node requests a target candidate SN (which may be the same as the Source SN or a neighbour SN) to configure a conditional PSCell Change (CPC) for at least one of its associated cells (cell associated to the target candidate SN).

This disclosure refers to CPAC as a way to refer to either a Conditional PSCell Addition (CPA) or a Conditional PSCell Change (CPC).

This disclosure refers to a neighbour SN and a Source SN as different entities, though both could be a target candidate SN for CPC.

The configuration of CPC can be done using the same IEs as conditional handover, which may be called at some point conditional configuration or conditional reconfiguration. The principle for the configuration is the same with configuring triggering/execution condition(s) and a reconfiguration message to be applied when the triggering condition(s) are fulfilled. The configuration IEs from TS 38.331 (Rel-17, v.17.0.0):

### —ConditionalReconfiguration

The IE ConditionalReconfiguration is used to add, modify and release the configuration of conditional configuration.

ConditionalReconfiguration information element
-- ASN1START
-- TAG-CONDITIONALRECONFIGURATION-START

| | |
|---|---|
| ConditionalReconfiguration-r16 ::= | SEQUENCE |

{
attemptCcondReconfig-r16

| | |
|---|---|
| ENUMERATED {true} | OPTIONAL, -- NEED N |

condConfigToRemoveList-r16

| | |
|---|---|
| CondConfigToRemoveList-r16 | OPTIONAL, -- Need N |

condConfigToAddModList-r16

| | |
|---|---|
| CondConfigToAddModList-r16 | OPTIONAL, -- Need N |

...
}

| | |
|---|---|
| CondConfigToRemoveList-r16 ::= | SEQUENCE (SIZE |

(1.. maxNrofCondCells)) OF CondConfigId-r16
-- TAG-CONDITIONALRECONFIGURATION-STOP
-- ASN1STOP

ConditionalReconfiguration field descriptions
condConfigToAddModList
List of the configuration of candidate SpCells to be added or modified for CHO or
CPC.
condConfigToRemoveList
List of the configuration of candidate SpCells to be removed. When the network
removes the stored conditional configuration for a candidate cell, the network
releases the measIDs associated to the condExecutionCond if it is not used by the
condExecutionCond of other candidate cells.

### —CondConfigId

The IE CondConfigId is used to identify a CHO or CPC configuration.

CondConfigId information element

| -- ASN1START | |
|---|---|
| -- TAG-CONDCONFIGID-START | |
| CondConfigId-r16 ::= | INTEGER (1.. |

maxNrofCond-Cells)
-- TAG-CONDCONFIGID-STOP
-- ASN1STOP

### —CondConfigToAddModList

The IE CHO-ConfigToAddModList concerns a list of conditional configurations to add or modify, with for each entry the cho-ConfigId and the associated condExecutionCond and condRRCReconfig.

CondConfigToAddModList information element
-- ASN1START
-- TAG-CONDCONFIGTOADDMODLIST-START

| | |
|---|---|
| CondConfigToAddModList-r16 ::= | SEQUENCE |

(SIZE (1.. maxNrofCondCells)) OF CondConfigToAddMod-r16

| | |
|---|---|
| CondConfigToAddMod-r16 ::= | SEQUENCE { |

```
  condConfigId-r16
CondConfigId-r16,
  condExecutionCond-r16
```

| | |
|---|---|
| SEQUENCE (SIZE (1..2)) OF MeasId OPTIONAL, | -- Need S |
| condRRCReconfig-r16 | OCTET |
| STRING (CONTAINING RRCReconfiguration) | OPTIONAL, -- Need S |

...
}
-- TAG-CONDCONFIGTOADDMODLIST-STOP
-- ASN1STOP

CondConfigToAddMod field descriptions
condExecutionCond
The execution condition that needs to be fulfilled in order to trigger the execution of a
conditional configuration. The field is mandatory present when a condConfigId is being
added. Otherwise, when the condRRCReconfig associated to a condConfigId is being
modified it is optionally present and the UE uses the stored value if the field is absent.
condRRCReconfig
The RRCReconfiguration message to be applied when the condition(s) are fulfilled. The
field is mandatory present when a condConfigId is being added. Otherwise, when the
condExecutionCond associated to a condConfigId is being modified it is optionally present
and the UE uses the stored value if the field is absent.

In the different embodiments these IEs are used differently e.g. sometimes generated by the MN, sometimes generated by the source SN, sometimes by a target candidate SN.

In the different embodiments it is said the CPC is in MN format when the CPC configuration is not configured as an MR-DC configuration in mrdc-SecondaryCellGroup (as defined in TS 38.331 (Rel-7, v.17.0.0). In other words, the UE receives an RRCReconfiguration from the MN that may contain the mrdc-SecondaryCellGroup (e.g. in case the UE is also configured with an SCG MeasConfig for inter-SN CPC) but the CPC is not within that container. That means the IEs listed above (e.g. the IE ConditionalReconfiguration) are not included in mrdc-SecondaryCellGroup.

In the different embodiments it is said the CPC is in SN format when the CPC configuration is configured as an MR-DC configuration in mrdc-SecondaryCellGroup (as defined in TS 38.331 (Rel-17, v.17.0.0). In other words, the UE receives an RRCReconfiguration from the MN that may contain the mrdc-SecondaryCellGroup and the CPC is within that container. That means the IEs listed above (e.g. the IE ConditionalReconfiguration) are included in mrdc-SecondaryCellGroup (e.g. within a series of other nested IEs).

The examples herein refer to a reference configuration and delta signaling.

In a set of embodiments a reference configuration comprises a set of parameter values for a set of parameter types, such as in reference configuration:
Parameter type 1=‘value_1’;
Parameter type 2=‘value_2’;
Parameter type 3=‘value_3’;
Parameter type 4=‘value_4’;

Parameter types may correspond to parameters within an RRC Reconfiguration message, such as fields and Information Elements (IEs), each having specific values when the UE receives a message. Hence, a reference configuration may be represented as an RRCReconfiguration to indicate that the reference configuration comprises one or more parameters, fields anD/or IEs of an RRCReconfiguration message.

In a set of embodiments a delta signaling (or delta signaling message) comprises a set of parameter values for a set of parameter types, and a set of parameters types whose values are left absent. The parameter types whose values are set indicate to the UE receiving the delta signaling message that these new values shall replace the existing values for the same parameter type. The parameter types whose values are absent indicate to the UE receiving the message that the UE shall use the values for these parameter types set in the reference configuration. To illustrate the concept, let us assume the following delta signaling, generated having as reference configuration the reference configuration in the previous example:
Parameter type 1=‘value_7’;
Parameter type 2=‘value_5’;
Parameter type 3=″;
Parameter type 4=″;

The UE receiving such delta signaling, having as reference configuration the reference configuration (1), applies the delta signaling to the current reference configuration (1), resulting in the following configuration:
Parameter type 1=‘value_7’ (i.e. ‘value_1’ replaced by ‘value_7’)
Parameter type 2=‘value_5’ (i.e. ‘value_2’ replaced by ‘value_5’)
Parameter type 3=‘value_3’ (i.e. ‘value_3’ remains, as value was absent in the delta signaling)
Parameter type 4=‘value_4’ (i.e. ‘value_4’ remains, as value was absent in the delta signaling)

### EMBODIMENTS OF THE DISCLOSURE

### Handling of Reference Configurations

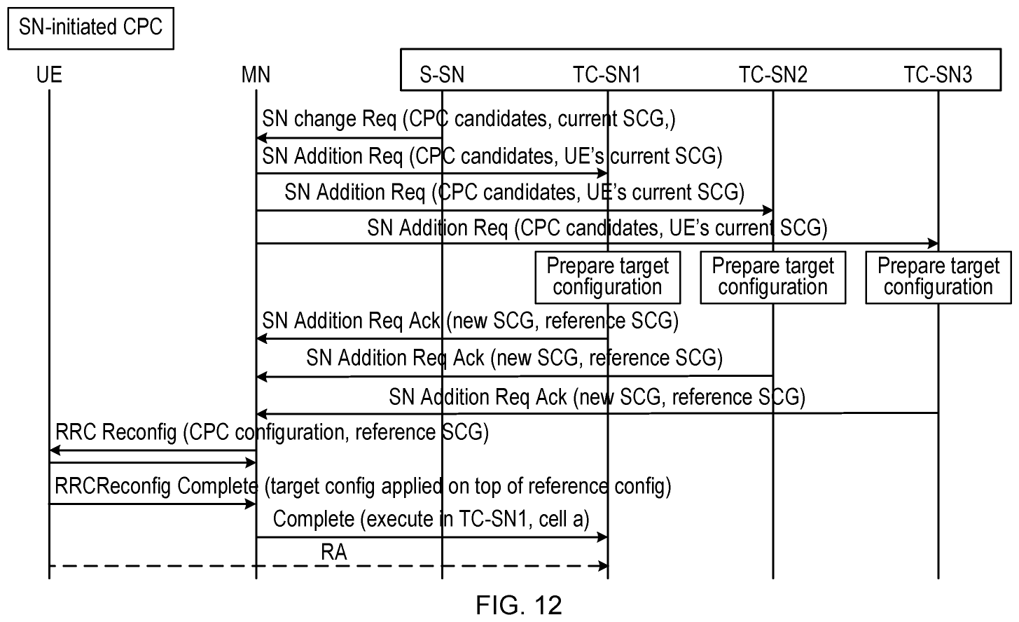

Reference configurations may be used in different use cases. FIG. 12 shows reference configuration being used at configuration and execution of conditional PSCell change, CPC.

The examples herein comprise a method executed by a User Equipment (UE) the method comprising: Receiving an RRC reconfiguration message, e.g. RRCReconfiguration, including one or more target candidate cell configurations, such as PSCell configuration(s) and/or SCG configurations (e.g. RRCReconfiguration* in MN format including at least an SCG RRC Reconfiguration) upon which the UE determines a reference configuration, where the reference configuration(s) is used as the configuration (which may be called a “source configuration”) towards which a delta configuration is applied.

In one set of embodiments the UE determines a reference configuration to be the reference configuration which is indicated by the network e.g. by different means. The reference configuration may have different content.

In one set of embodiments, the reference configuration comprises the current UE configuration e.g. the UE's configuration when the UE receives the RRC Reconfiguration message.

The current UE configuration may comprise the configuration the UE is operating when it receives the RRC Reconfiguration message from the MN e.g. the UE's current SCG configuration.

The reference configuration (or an indication of it e.g. pointer, identifier) may be signaled explicitly to the UE, upon which the UE may store the current configuration as the reference configuration.

It may be standardized that the UE is aware that the current configuration is to be considered the reference configuration; or, the UE knows that because it is hard coded, or it is in the UE memory, or it is indicated implicitly that the current configuration upon configuration is the reference configuration e.g. by the absence of an explicit field and/or IE.

What is considered to be the current configuration comprises the configuration the UE had before applying the RRC reconfiguration message including the one or more target candidate cell configurations (for CPC) or after applying the RRC reconfiguration message. The RRC reconfiguration message that is applied may be a message signaled at that point in time, or a stored message received earlier.

In one option, the reference configuration comprises an MCG part and/or an SCG part. The need for an MCG part may be due to the fact that the message to be applied upon CPC execution is in MN format (RRCReconfiguration*), including an SCG RRC Reconfiguration (RRCReconfiguration**) generated by the target candidate SN.

In another option, the UE stores two separate reference configurations, one for the MCG and one for the SCG. That way it is possible to update the reference configurations for the MCG and for the SCG separately, e.g. in case of a procedure where only the SCG reference configuration is to be updated.

In one option, the reference configuration comprises the current configuration, which is stored in a UE variable by the UE e.g. either when the UE is configured with CPC, or when the UE is configured for the first time with the RRC Reconfiguration when it comes from RRC_IDLE.

In one set of embodiments the UE determines that the reference configuration is the configuration of one of the target candidates for conditional reconfiguration in which the UE has been configured with e.g. one of the full configurations.

In one set of embodiments the UE determines that the reference configuration is a default configuration e.g. stored in UE's memory. That may be a configuration which is standardized and known to the UE.

In one set of embodiments the UE receives an indication of which configuration is the reference configuration. E.g. the UE source configuration or one of the UE target candidate configuration(s), indicated to be indicated to be the reference configuration.

The indication of reference configuration could be a separate indication referring to the reference configuration.

The indication could be an identity of the configuration that is the reference configuration.

In a first option, the target candidate configuration indicated to be the reference is a full configuration i.e. that is stored and used as reference so if the UE needs to apply another target candidate configuration, it applies on top of that indicated configuration (which is a full configuration).

In a second option, the target candidate configuration indicated to be the reference configuration is also a delta signaling (or delta configuration i.e. may contain some parameter types with values being absent). Upon reception of that the UE first needs to generate a full configuration version of that (without absent parameter types) to be the actual reference, i.e., the UE generates a full configuration version by applying the delta on top of its current configuration and storing the result.

In one alternative the target candidate configuration that is indicated to be the reference for a delta configuration (delta_config_X) is also a delta configuration (delta_config_1) on top of another reference configuration (reference_config_1), but the UE stores these configurations separately and applies the delta configuration (delta_config_X) in multiple steps, as reference_config_1+delta_config_1+delta_config_X.

In one set of embodiments the whole reference configuration may be signaled explicitly, separated from the current configuration and/or from the current configuration. One or multiple reference configurations may be signaled and each reference configuration may have an identity.

In one set of embodiments, different target candidate configuration(s) which are delta signaling may have different reference configuration(s). The UE may store multiple reference configuration(s), for the different target candidate configuration(s) which are also stored.

In one set of embodiments, a subset of target candidate configuration(s) which are delta signaling may have a first reference configuration, while another subset of target candidate configuration(s) may have a second reference configuration. This may be interesting in case each target candidate SN may determine its reference configuration.

In one set of embodiments the reference configuration is determined to be a configuration related to the occurrence of certain events, e.g. state transitions, so that the UE e.g. stores the configuration as a reference configuration when transferring to RRC_CONNECTED. The occurrence of the event may determine that the UE shall store the reference configuration.

In one option, the reference configuration is the resulting RRC configuration the UE has after receiving and applying the RRCSetup message (for configuring SRB1) when the UE transitions from RRC_IDLE to RRC_CONNECTED. Notice that DRBs and security are not part of the RRC Setup message, so that this configuration would be limited and the target candidates, when generating their delta configuration(s) may need to be taken into account. Or, the MN, which signals the reference configuration to the Target candidates.

In one option, the reference configuration is the resulting RRC configuration the UE has after receiving and applying the first RRC Reconfiguration message (for configuring SRB1) when the UE transitions from RRC_IDLE to RRC_CONNECTED. This allows the reference configuration to have DRBs configured, but also security (as that is after initial security activation).

In one option, in case the UE transitions from RRC_INACTIVE to RRC_CONNECTED, the reference configuration is the resulting RRC configuration the UE has after receiving and applying the RRCResume message. In one option the reference configuration is the resulting RRC configuration that the UE has after receiving and applying the first RRC Reconfiguration message after the reception of the RRCResume message.

In one option, the event is the first RRC Reconfiguration after Re-establishment. The resulting configuration after having applied the RRC Reconfiguration may be determined to be the reference configuration.

In one option, the event is a reconfiguration with sync e.g. the reference configuration is the resulting configuration after the handover and/or PSCell change and/or PSCell addition.

In one option, the UE keeps the stored reference configuration(s) at transition from RRC_CONNECTED to RRC_INACTIVE and then restores it/them when resuming to RRC_CONNECTED again. In one alternative, the network indicates to the UE what reference configuration(s) to keep when the UE resume the connection, e.g. in the RRCResume message or in a subsequent RRC Reconfiguration message. In one alternative the RRCResume message (and/or the subsequent RRC Reconfiguration message) is a delta configuration for one of the stored reference configurations. The network then provides a configuration in the RRCResume message (and/or the subsequent RRC Reconfiguration message) that it is a delta configuration on top of a stored reference configuration where the UE then applies the received configuration on top of the corresponding stored reference configuration. In one example, the UE receives an indication from the network in the RRCResume message (and/or the subsequent RRC Reconfiguration message) about what stored reference configuration that the included configuration should be applied on top of, e.g. as an identity of the corresponding stored reference configuration.

A reference configuration may be a complete configuration, i.e. comprising all parameters of the UE configuration, or it may be part of configuration. If the reference configuration is not a complete configuration, the network may indicate in signaling the values of the parameters that are not part of the reference configuration.

In one set of embodiments the UE receives an indication to first apply the reference configuration and then apply the delta configuration on top. This could be indicated explicitly in signaling. This could be indicated implicitly or standardized that the UE first applies the reference configuration before applying the delta configuration if the UE has a received or stored a reference configuration. In one option the UE receives an indication that it shall apply a specific reference configuration, e.g. as indicated through an identity of the reference configuration, and then apply a delta configuration on top of that configuration.

The method may comprise transmitting a response message to the network indicating the successful configuration, e.g. RRCReconfigurationComplete.

When a condition(s) for a conditional reconfiguration is fulfilled (e.g. sometime after the UE receives the CPC configurations), applying or using a reference configuration as a source configuration and adding a delta configuration on top of the source configuration.

In one set of embodiments, the UE determines the reference configuration before the UE needs to use it with the delta signaling of the selected cell for executing CPC. In one option the UE determines the reference configuration and generates a full configuration version by applying the delta signaling on top of the reference configuration i.e. what is stored is the full configuration version per target candidate and, that is what it is applied to the UE (not on top of the UE's current configuration).

In one set of embodiments, the UE determines the reference configuration when the UE needs to use it with the delta signaling of the selected cell for executing CPC e.g. as part of the execution procedure for CPC, before applying the delta signaling.

The method may further comprise transmitting a response message to the network of the successful execution, e.g. RRCReconfigurationComplete.

In one set of embodiments the reference configuration is a configuration generated by the MN. This may be a configuration the MN indicates to each Target Candidate SN (TC-SN) which wants to generate a delta signaling for a target candidate configuration e.g. in the SN Addition Request. That may be transparent to the TC-SN, as the TC-SN could interpret the signaled reference configurations as the UE's current configuration. Different TC-SNs may receive different reference configurations.

In one set of embodiments the reference configuration is a configuration generated by the S-SN. That is a configuration the S-SN indicates to the MN e.g. in the SN Modification Required requesting CPC (SN-initiated CPC). The MN indicates the reference configuration to a TC-SN which wants to generate a delta signaling for a target candidate configuration e.g. in the SN Addition Request. This may be transparent to the TC-SN, as the TC-SN could interpret the signaled reference configurations as the UE's current configuration. It may also be transparent to the MN. Different TC-SNs may receive different reference configurations. The MN may receive different reference configurations for different target candidate cells and/or TC-SNs.

In one set of embodiments the reference configuration is a configuration generated by a TC-SN. That is a configuration the TC-SN indicates to the MN e.g. in the SN Addition Request Ack, with the target candidate configuration. The MN may receive different reference configurations for different target candidate cells and/or TC-SNs. In one option, a TC-SN indicates one of its full configuration(s) for a target candidates to be a reference configuration to other delta configurations i.e. of other target candidate cells.

In an example there is a method executed by a source Secondary Node (S-SN) the method comprising:
In case of SN initiated CPC, determining to configure CPC.
In case of SN initiated CPC, transmitting to the MN a request for CPC, including CPC candidates and current SCG configuration as part of a request for CPC.
In one option, the source SN indicates to the MN that the current SCG configuration may be used as a reference configuration.

In one option, the source SN (also) signals a reference configuration as part of the request for CPC or indicates a reference configuration.

In an example there is a method executed by a Master Node (MN) the method comprising:
In case of SN initiated CPC, receiving a request for CPC, including CPC candidates and current SCG configuration as part of the request for CPC.
Transmitting, to the TC-SN(s), requests message(s) for CPC, the message(s) comprising:
   The CPC candidates and the current SCG configuration. Alternatively, transmitting a reference configuration(s) to T-SN or both the current SCG configuration and reference configuration(s). The reference configuration(s) may comprise an SCG configuration, or, alternatively, may comprise both MCG and SCG configuration, or only MCG configuration.

The method may further comprise receiving response message(s) from TC-SN(s). The message(s) comprising:
Target SCG configuration, e.g. for CPC.
Reference configuration(s) or indication of reference configuration(s), see further method for UE regarding options for reference configuration(s).

Possibly adding MCG related information to the reference configuration(s).

The method may further comprise transmitting, to the UE, an RRC reconfiguration message, e.g. RRCReconfiguration, including one or more target candidate cell configurations, such as PSCell configuration(s) and/or SCG configurations (e.g. RRCReconfiguration* in MN format including at least an SCG RRC Reconfiguration) upon which the UE determines a reference configuration, where the reference configuration(s) is used as the configuration (which may be called a “source configuration”) towards which a delta configuration is applied.

In one set of embodiments a reference configuration may be determined to be the reference configuration indicated by the network e.g. by different means. The reference configuration may have different content.

In one set of embodiments, the reference configuration comprises the current UE configuration e.g. the UE's configuration when the UE receives the RRC Reconfiguration message.

The current UE configuration may comprise the configuration the UE is operating when the RRC Reconfiguration message is transmitted from the MN e.g. the UE's current SCG configuration.

The reference configuration (or an indication of it e.g. pointer, identifier) may be signaled explicitly to the UE.

It may be standardized that the UE is aware that the current configuration is to be considered the reference configuration; or, the UE knows that because it is hard coded, or it is in the UE memory, or it is indicated implicitly that the current configuration upon configuration is the reference configuration e.g. by the absence of an explicit field and/or IE.

What is considered to be the current configuration may comprise the configuration the UE had before applying the RRC reconfiguration message including the one or more target candidate cell configurations (for CPC) or after applying the RRC reconfiguration message. The RRC reconfiguration message that is applied may be a message signaled at that point in time, or a stored message received earlier.

In one option, the reference configuration comprises an MCG part and/or an SCG part. The need for an MCG part may be due to the fact that the message to be applied upon CPC execution is in MN format (RRCReconfiguration*), including an SCG RRC Reconfiguration (RRCReconfiguration**) generated by the target candidate SN.

In another option, the two separate reference configurations are signalled, one for the MCG and one for the SCG. That way it is possible to update the reference configurations for the MCG and for the SCG separately, e.g. in case of a procedure where only the SCG reference configuration is to be updated.

In one option, the reference configuration comprises the current configuration, which is stored in a UE variable by the UE e.g. either when the UE is configured with CPC, or when the UE is configured for the first time with the RRC Reconfiguration when it comes from RRC_IDLE.

In one set of embodiments the UE determines that the reference configuration is the configuration of one of the target candidates for conditional reconfiguration in which the UE has been configured with e.g. one of the full configurations.

In one set of embodiments the UE determines that the reference configuration is a default configuration e.g. stored in UE's memory. That may be a configuration which is standardized and known to the UE.

In one set of embodiments the MN signals an indication of which configuration is the reference configuration, e.g. the UE source configuration or one of the UE target candidate configuration(s), indicated to be indicated to be the reference configuration.

The indication of reference configuration could be a separate indication referring to the reference configuration.

The indication could be an identity of the configuration that is the reference configuration.

In a first option, the target candidate configuration indicated to be the reference is a full configuration i.e. that is stored and used as reference so if the UE needs to apply another target candidate configuration, it applies on top of that indicated configuration (which is a full configuration).

In a second option, the target candidate configuration indicated to be the reference configuration is also a delta signaling (or delta configuration i.e. may contain some parameter types with values being absent). Upon reception of that the UE first needs to generate a full configuration version of that (without absent parameter types) to be the actual reference, i.e., the UE generates a full configuration version by applying the delta on top of its current configuration and storing the result.

In one alternative the target candidate configuration that is indicated to be the reference for a delta configuration (delta_config_X) is also a delta configuration (delta_config_1) on top of another reference configuration (reference_config_1), but the UE stores these configurations separately and applies the delta configuration (delta_config_X) in multiple steps, as reference_config_1+delta_config_1+delta_config_X.

In one set of embodiments the whole reference configuration may be signaled explicitly, separated from the current configuration and/or from the current configuration. One or multiple reference configurations may be signaled and each reference configuration may have an identity.

In one set of embodiments, different target candidate configuration(s) which are delta signaling may have different reference configuration(s). The UE may store multiple reference configuration(s), for the different target candidate configuration(s) which are also stored.

In one set of embodiments, a subset of target candidate configuration(s) which are delta signaling may have a first reference configuration, while another subset of target candidate configuration(s) may have a second reference configuration. This may be interesting in case each target candidate SN may determine its reference configuration.

In one set of embodiments the reference configuration is determined to be a configuration related to the occurrence of certain events, e.g. state transitions, so that the UE e.g. stores the configuration as a reference configuration when transferring to RRC_CONNECTED. The occurrence of the event may determine that the UE shall store the reference configuration.

In one option, the reference configuration is the resulting RRC configuration the UE has after receiving and applying the RRCSetup message (for configuring SRB1) when the UE transitions from RRC_IDLE to RRC_CONNECTED. Notice that DRBs and security are not part of the RRC Setup message, so that this configuration would be limited and the target candidates, when generating their delta configuration(s) needs to take that into account. Or, the MN, which signals the reference configuration to the Target candidates.

In one option, the reference configuration is the resulting RRC configuration the UE has after receiving and applying the first RRC Reconfiguration message (for configuring SRB1) when the UE transitions from RRC_IDLE to RRC_CONNECTED. That allows the reference configuration to have DRBs configured, but also security (as that is after initial security activation).

In one option, in case the UE transitions from RRC_INACTIVE to RRC_CONNECTED, the reference configuration is the resulting RRC configuration the UE has after receiving and applying the RRCResume message. In one option the reference configuration is the resulting RRC configuration that the UE has after receiving and applying the first RRC Reconfiguration message after the reception of the RRCResume message.

In one option, the event is the first RRC Reconfiguration after Re-establishment. The resulting configuration after having applied the RRC Reconfiguration is determined to be the reference configuration.

In one option, the event is a reconfiguration with sync e.g. the reference configuration is the resulting configuration after the handover and/or PSCell change and/or PSCell addition.

In one option, the UE keeps the stored reference configuration(s) at transition from RRC_CONNECTED to RRC_INACTIVE and then restores it/them when resuming to RRC_CONNECTED again. In one alternative, the network indicates to the UE what reference configuration(s) to keep when the UE resume the connection, e.g. in the RRCResume message or in a subsequent RRC Reconfiguration message. In one alternative the RRCResume message (and/or the subsequent RRC Reconfiguration message) is a delta configuration for one of the stored reference configurations. The network then provides a configuration in the RRCResume message (and/or the subsequent RRC Reconfiguration message) that it is a delta configuration on top of a stored reference configuration where the UE then applies the received configuration on top of the corresponding stored reference configuration. In one example, the network transmits an indication in the RRCResume message (and/or the subsequent RRC Reconfiguration message) about what stored reference configuration that the included configuration should be applied on top of, e.g. as an identity of the corresponding stored reference configuration.

A reference configuration may be a complete configuration, i.e. comprising all parameters of the UE configuration, or it may be part of configuration. If the reference configuration is not a complete configuration, the network will indicate in signaling the values of the parameters that are not part of the reference configuration.

In one set of embodiments the network signals an indication to first apply the reference configuration and then apply the delta configuration on top.

This could be indicated explicitly in signaling.

This could be indicated implicitly or standardized that the UE first applies the reference configuration before applying the delta configuration if the UE has a received or stored a reference configuration.

In one option the UE receives an indication that it shall apply a specific reference configuration, e.g. as indicated through an identity of the reference configuration, and then apply a delta configuration on top of that configuration.

In an example the method further comprises receiving a response message from the UE indicating the successful configuration, e.g. RRCReconfigurationComplete.

In an example the method further comprises receiving a response message from the UE of the successful execution of CPC, e.g. RRCReconfigurationComplete.

In an example the method further comprises transmitting a message to the target SN T-SN, informing T-SN that the UE has executed CPC and to which cell the UE executed the CPC.

The MN may at any time transmit message(s) to the UE with update of the CPC configuration(s) and/or reference configuration(s).

In an example there is provided a method executed by a Target Candidate Secondary Node (TC-SN) the method comprising:

Receiving, from the MN, requests message(s) for CPC, the message(s) comprising the CPC candidates and the current SCG configuration. Alternatively, receiving a reference configuration(s) or both the current SCG configuration and reference configuration(s). The reference configuration(s) may comprise an SCG configuration, or, alternatively, may comprise both MCG and SCG configuration, or only MCG configuration.

In an example the method further comprises determining whether to define reference configuration(s) for the UE to use.

In an example the method further comprises transmitting a response message(s) to the MN. The message(s) may comprise: Target SCG configuration, e.g. for CPC; Reference configuration(s) or indication of reference configuration(s), see further method for UE regarding options for reference configuration(s).

In an example the method further comprises receiving a message from the MN containing information that the UE has executed CPC and to which cell the UE executed the CPC.

### Example Implementation

The following is an example implementation in RRC specification TS 38.331 of addition of a list of reference configurations. It also shows an example of use of reference configurations at execution of a conditional reconfiguration. The changes compared to existing specification v 16.7.0 are in bold font and highlighted in grey.

### 5.3.5 RRC Reconfiguration

[. . . ]

### 5.3.5.13.5 Conditional Reconfiguration Execution

The UE shall:
1> if more than one triggered cell exists:
   2> select one of the triggered cells as the selected cell for conditional reconfiguration execution;
1> for the selected cell of conditional reconfiguration execution:
   2> if referenceConfigId is indicated for the selected cell in the applied message:
      3> first apply the referenceConfig for the indicated referenceConfigId and then apply the stored condRRCReconfig of the selected cell and perform the actions as specified in 5.3.5.3;
1> else:
   2> apply the stored condRRCReconfig of the selected cell and perform the actions as specified in 5.3.5.3;
NOTE: If multiple NR cells are triggered in conditional reconfiguration execution, it is up to UE implementation which one to select, e.g. the UE considers beams and beam quality to select one of the triggered cells for execution.

### 5.3.5.X Reference Configuration Addition/Modification

For each referenceConfigId received in the referenceConfigToAddModList IE the UE shall:
1> if an entry with the matching referenceConfigId exists in the referencConfigToAddModList within the VarReferenceConfig:
   2> replace referenceConfig within the VarReferenceConfig with the value received for this referenceConfigId;
1> else:
   2> add a new entry for this referenceConfigId within the VarReferenceConfig;

Or alternatively to 5.3.5.X, where the reference configuration is one stored configuration:

### 5.3.5.3 Reception of an RRCReconfiguration by the UE

The UE shall perform the following actions upon reception of the RRCReconfiguration, or upon execution of the conditional reconfiguration (CHO, CPA or CPC):

[. . . ]
1> else:
   2> if the RRCReconfiguration includes the fullConfig:
      3> perform the full configuration procedure as specified in 5.3.5.11;
1> if the RRCReconfiguration includes the storeCurrentConfiguration set to true:
   2> store the current configuration in referenceConfig within the VarReferenceConfig;

### 6.3.2 Radio Resource Control Information Elements

[. . . ]

### —CellGroupConfig

The CellGroupConfig IE is used to configure a master cell group (MCG) or secondary cell group (SCG). A cell group comprises of one MAC entity, a set of logical channels with associated RLC entities and of a primary cell (SpCell) and one or more secondary cells (SCells).

CellGroupConfig information element
-- ASN1START
-- TAG-CELLGROUPCONFIG-START
-- Configuration of one Cell-Group:
[..]
-- Serving cell specific MAC and PHY parameters for a SpCell:

| SpCellConfig ::= | SEQUENCE { |
|---|---|
| servCellIndex | ServCellIndex |
| OPTIONAL, -- Cond SCG | |
| reconfigurationWithSync | |
| ReconfigurationWithSync | |
| OPTIONAL, -- Cond ReconfWithSync | |
| rlf-TimersAndConstants | SetupRelease { RLF- |
| TimersAndConstants } | OPTIONAL, -- Need M |
| rlmInSyncOutOfSyncThreshold | ENUMERATED |
| {n1} | OPTIONAL, - |
| - Need S | |
| spCellConfigDedicated | ServingCellConfig |
| OPTIONAL, -- Need M | |
| ..., | |
| [[ referenceConfigId-r18 | ReferenceConfigId-r18 |

OPTIONAL, -- Need M
]]
}
[..]
-- TAG-CELLGROUPCONFIG-STOP
-- ASN1STOP

CellGroupConfig field descriptions
referenceConfigId
Indicates the referenceConfig to be used as source configuration when
applying the CellGroupConfig.
[..]

### —ReferenceConfigToAddModList

The IE ReferenceConfigToAddModList concerns a list of reference configurations to add or modify, with for each entry the referenceConfigId and the associated referenceConfig.

ReferenceConfigToAddModList information element
-- ASN1START
-- TAG-REFERENCECONFIGTOADDMODLIST-START
ReferenceConfigToAddModList-r18 ::= SEQUENCE (SIZE (1..
maxNrofCondCells-r18)) OF ReferenceConfigToAddMod-r18

| | |
|---|---|
| ReferenceConfigToAddMod-r18 ::= | SEQUENCE { |
| referenceConfigId-r18 | ReferenceConfigId-r18 |

-- Need M,

| | |
|---|---|
| referenceConfig-r18 | OCTET STRING |
| (CONTAINING RRCReconfiguration) | OPTIONAL, -- Need M, |
| storeCurrentConfiguration | BOOLEAN, |

...
}
-- TAG-REFERENCECONFIGTOADDMODLIST-STOP
-- ASN1STOP
ReferenceConfigToAddMod field descriptions
referenceRRCReconfig
The RRCReconfiguration message to be stored and used as source
configuration when delta configuration is applied.
storeCurrentConfiguration
This field indicates that the UE shall store the current configuration as
referenceConfig to be used when delta configuration is applied.

### 7.4 UE Variables

[..]

### —VarReferenceConfig

The UE variable VarReferenceConfig includes the accumulated configuration of reference configurations.

VarReferenceConfig UE variable

-- ASN1START
-- TAG-VARREFERENCECONFIG-START
VarReferenceConfig ::= SEQUENCE {
referenceConfigList
ReferenceConfigToAddModList-r18 OPTIONAL
}
-- TAG-VARCONDITIONALRECONFIG-STOP
-- ASN1STOP

FIG. 13 shows an example of a communication system 1300 in accordance with some embodiments.

In the example, the communication system 1300 includes a telecommunication network 1302 that includes an access network 1304, such as a radio access network (RAN), and a core network 1306, which includes one or more core network nodes 1308. The access network 1304 includes one or more access network nodes, such as network nodes 1310a and 1310b (one or more of which may be generally referred to as network nodes 1310), or any other similar 3^{rd} Generation Partnership Project (3GPP) access node or non-3GPP access point. The network nodes 1310 facilitate direct or indirect connection of user equipment (UE), such as by connecting UEs 1312a, 1312b, 1312c, and 1312d (one or more of which may be generally referred to as UEs 1312) to the core network 1306 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1300 may include any number of wired or wireless networks, network nodes, UEs, and/or any other components or systems that may facilitate or participate in the communication of data and/or signals whether via wired or wireless connections. The communication system 1300 may include and/or interface with any type of communication, telecommunication, data, cellular, radio network, and/or other similar type of system.

The UEs 1312 may be any of a wide variety of communication devices, including wireless devices arranged, configured, and/or operable to communicate wirelessly with the network nodes 1310 and other communication devices. Similarly, the network nodes 1310 are arranged, capable, configured, and/or operable to communicate directly or indirectly with the UEs 1312 and/or with other network nodes or equipment in the telecommunication network 1302 to enable and/or provide network access, such as wireless network access, and/or to perform other functions, such as administration in the telecommunication network 1302.

In the depicted example, the core network 1306 connects the network nodes 1310 to one or more hosts, such as host 1316. These connections may be direct or indirect via one or more intermediary networks or devices. In other examples, network nodes may be directly coupled to hosts. The core network 1306 includes one more core network nodes (e.g., core network node 1308) that are structured with hardware and software components. Features of these components may be substantially similar to those described with respect to the UEs, network nodes, and/or hosts, such that the descriptions thereof are generally applicable to the corresponding components of the core network node 1308. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1316 may be under the ownership or control of a service provider other than an operator or provider of the access network 1304 and/or the telecommunication network 1302, and may be operated by the service provider or on behalf of the service provider. The host 1316 may host a variety of applications to provide one or more services. Examples of such applications include the provision of live and/or pre-recorded audio/video content, data collection services, for example, retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1300 of FIG. 13 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1302 is a cellular network that implements 3GPP standardized features. Accordingly, the telecommunications network 1302 may support network slicing to provide different logical networks to different devices that are connected to the telecommunication network 1302. For example, the telecommunications network 1302 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1312 are configured to transmit and/or receive information without direct human interaction. For instance, a UE may be designed to transmit information to the access network 1304 on a predetermined schedule, when triggered by an internal or external event, or in response to requests from the access network 1304. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example illustrated in FIG. 13, the hub 1314 communicates with the access network 1304 to facilitate indirect communication between one or more UEs (e.g., UE 1312c and/or 1312d) and network nodes (e.g., network node 1310b). In some examples, the hub 1314 may be a controller, router, a content source and analytics node, or any of the other communication devices described herein regarding UEs. For example, the hub 1314 may be a broadband router enabling access to the core network 1306 for the UEs. As another example, the hub 1314 may be a controller that sends commands or instructions to one or more actuators in the UEs. Commands or instructions may be received from the UEs, network nodes 1310, or by executable code, script, process, or other instructions in the hub 1314. As another example, the hub 1314 may be a data collector that acts as temporary storage for UE data and, in some embodiments, may perform analysis or other processing of the data. As another example, the hub 1314 may be a content source. For example, for a UE that is a VR headset, display, loudspeaker or other media delivery device, the hub 1314 may retrieve VR assets, video, audio, or other media or data related to sensory information via a network node, which the hub 1314 then provides to the UE either directly, after performing local processing, and/or after adding additional local content. In still another example, the hub 1314 acts as a proxy server or orchestrator for the UEs, in particular in if one or more of the UEs are low energy IoT devices.

The hub 1314 may have a constant/persistent or intermittent connection to the network node 1310b. The hub 1314 may also allow for a different communication scheme and/or schedule between the hub 1314 and UEs (e.g., UE 1312c and/or 1312d), and between the hub 1314 and the core network 1306. In other examples, the hub 1314 is connected to the core network 1306 and/or one or more UEs via a wired connection. Moreover, the hub 1314 may be configured to connect to an M2M service provider over the access network 1304 and/or to another UE over a direct connection. In some scenarios, UEs may establish a wireless connection with the network nodes 1310 while still connected via the hub 1314 via a wired or wireless connection. In some embodiments, the hub 1314 may be a dedicated hub—that is, a hub whose primary function is to route communications to/from the UEs from/to the network node 1310b. In other embodiments, the hub 1314 may be a non-dedicated hub—that is, a device which is capable of operating to route communications between the UEs and network node 1310b, but which is additionally capable of operating as a communication start and/or end point for certain data channels.

FIG. 14 shows a UE 1400 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless camera, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1400 includes processing circuitry 1402 that is operatively coupled via a bus 1404 to an input/output interface 1406, a power source 1408, a memory 1410, a communication interface 1412, and/or any other component, or any combination thereof. Certain UEs may utilize all or a subset of the components shown in FIG. 14. The level of integration between the components may vary from one UE to another UE. Further, certain UEs may contain multiple instances of a component, such as multiple processors, memories, transceivers, transmitters, receivers, etc.

The processing circuitry 1402 is configured to process instructions and data and may be configured to implement any sequential state machine operative to execute instructions stored as machine-readable computer programs in the memory 1410. The processing circuitry 1402 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1402 may include multiple central processing units (CPUs). The processing circuitry 1402 may be operable to provide, either alone or in conjunction with other UE 1400 components, such as the memory 1410, UE 1400 functionality. For example, the processing circuitry 1402 may be configured to cause the UE 1402 to perform the methods as described with reference to FIG. 7.

In the example, the input/output interface 1406 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1400. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1408 is structured as a battery or battery pack. Other types of power sources, such as an external power source (e.g., an electricity outlet), photovoltaic device, or power cell, may be used. The power source 1408 may further include power circuitry for delivering power from the power source 1408 itself, and/or an external power source, to the various parts of the UE 1400 via input circuitry or an interface such as an electrical power cable. Delivering power may be, for example, for charging of the power source 1408. Power circuitry may perform any formatting, converting, or other modification to the power from the power source 1408 to make the power suitable for the respective components of the UE 1400 to which power is supplied.

The memory 1410 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1410 includes one or more application programs 1414, such as an operating system, web browser application, a widget, gadget engine, or other application, and corresponding data 1416. The memory 1410 may store, for use by the UE 1400, any of a variety of various operating systems or combinations of operating systems.

The memory 1410 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1410 may allow the UE 1400 to access instructions, application programs and the like, stored on transitory or non-transitory memory media, to off-load data, or to upload data. An article of manufacture, such as one utilizing a communication system may be tangibly embodied as or in the memory 1410, which may be or comprise a device-readable storage medium.

The processing circuitry 1402 may be configured to communicate with an access network or other network using the communication interface 1412. The communication interface 1412 may comprise one or more communication subsystems and may include or be communicatively coupled to an antenna 1422. The communication interface 1412 may include one or more transceivers used to communicate, such as by communicating with one or more remote transceivers of another device capable of wireless communication (e.g., another UE or a network node in an access network). Each transceiver may include a transmitter 1418 and/or a receiver 1420 appropriate to provide network communications (e.g., optical, electrical, frequency allocations, and so forth). Moreover, the transmitter 1418 and receiver 1420 may be coupled to one or more antennas (e.g., antenna 1422) and may share circuit components, software or firmware, or alternatively be implemented separately.

In some embodiments, communication functions of the communication interface 1412 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1412, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or controls a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are devices which are or which are embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence on the intended application of the IoT device in addition to other components as described in relation to the UE 1400 shown in FIG. 14.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 15 shows a network node 1500 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1500 includes processing circuitry 1502, a memory 1504, a communication interface 1506, and a power source 1508, and/or any other component, or any combination thereof. The network node 1500 may be composed of multiple physically separate components (e.g., a NodeB component and a RNC component, or a BTS component and a BSC component, etc.), which may each have their own respective components. In certain scenarios in which the network node 1500 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1500 may be configured to support multiple radio access technologies (RATs). In such embodiments, some components may be duplicated (e.g., separate memory 1504 for different RATs) and some components may be reused (e.g., a same antenna 1510 may be shared by different RATs). The network node 1500 may also include multiple sets of the various illustrated components for different wireless technologies integrated into network node 1500, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1500.

The processing circuitry 1502 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1500 components, such as the memory 1504, network node 1500 functionality. For example, the processing circuitry 1502 may be configured to cause the network node to perform the methods as described with reference to FIGS. 9, 10, 11, and/or 12.

In some embodiments, the processing circuitry 1502 includes a system on a chip (SOC). In some embodiments, the processing circuitry 1502 includes one or more of radio frequency (RF) transceiver circuitry 1512 and baseband processing circuitry 1514. In some embodiments, the radio frequency (RF) transceiver circuitry 1512 and the baseband processing circuitry 1514 may be on separate chips (or sets of chips), boards, or units, such as radio units and digital units. In alternative embodiments, part or all of RF transceiver circuitry 1512 and baseband processing circuitry 1514 may be on the same chip or set of chips, boards, or units.

The memory 1504 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1502. The memory 1504 may store any suitable instructions, data, or information, including a computer program, software, an application including one or more of logic, rules, code, tables, and/or other instructions capable of being executed by the processing circuitry 1502 and utilized by the network node 1500. The memory 1504 may be used to store any calculations made by the processing circuitry 1502 and/or any data received via the communication interface 1506. In some embodiments, the processing circuitry 1502 and memory 1504 is integrated.

The communication interface 1506 is used in wired or wireless communication of signaling and/or data between a network node, access network, and/or UE. As illustrated, the communication interface 1506 comprises port(s)/terminal(s) 1516 to send and receive data, for example to and from a network over a wired connection. The communication interface 1506 also includes radio front-end circuitry 1518 that may be coupled to, or in certain embodiments a part of, the antenna 1510. Radio front-end circuitry 1518 comprises filters 1520 and amplifiers 1522. The radio front-end circuitry 1518 may be connected to an antenna 1510 and processing circuitry 1502. The radio front-end circuitry may be configured to condition signals communicated between antenna 1510 and processing circuitry 1502. The radio front-end circuitry 1518 may receive digital data that is to be sent out to other network nodes or UEs via a wireless connection. The radio front-end circuitry 1518 may convert the digital data into a radio signal having the appropriate channel and bandwidth parameters using a combination of filters 1520 and/or amplifiers 1522. The radio signal may then be transmitted via the antenna 1510. Similarly, when receiving data, the antenna 1510 may collect radio signals which are then converted into digital data by the radio front-end circuitry 1518. The digital data may be passed to the processing circuitry 1502. In other embodiments, the communication interface may comprise different components and/or different combinations of components.

In certain alternative embodiments, the network node 1500 does not include separate radio front-end circuitry 1518, instead, the processing circuitry 1502 includes radio front-end circuitry and is connected to the antenna 1510. Similarly, in some embodiments, all or some of the RF transceiver circuitry 1512 is part of the communication interface 1506. In still other embodiments, the communication interface 1506 includes one or more ports or terminals 1516, the radio front-end circuitry 1518, and the RF transceiver circuitry 1512, as part of a radio unit (not shown), and the communication interface 1506 communicates with the baseband processing circuitry 1514, which is part of a digital unit (not shown).

The antenna 1510 may include one or more antennas, or antenna arrays, configured to send and/or receive wireless signals. The antenna 1510 may be coupled to the radio front-end circuitry 1518 and may be any type of antenna capable of transmitting and receiving data and/or signals wirelessly. In certain embodiments, the antenna 1510 is separate from the network node 1500 and connectable to the network node 1500 through an interface or port.

The antenna 1510, communication interface 1506, and/or the processing circuitry 1502 may be configured to perform any receiving operations and/or certain obtaining operations described herein as being performed by the network node. Any information, data and/or signals may be received from a UE, another network node and/or any other network equipment. Similarly, the antenna 1510, the communication interface 1506, and/or the processing circuitry 1502 may be configured to perform any transmitting operations described herein as being performed by the network node. Any information, data and/or signals may be transmitted to a UE, another network node and/or any other network equipment.

The power source 1508 provides power to the various components of network node 1500 in a form suitable for the respective components (e.g., at a voltage and current level needed for each respective component). The power source 1508 may further comprise, or be coupled to, power management circuitry to supply the components of the network node 1500 with power for performing the functionality described herein. For example, the network node 1500 may be connectable to an external power source (e.g., the power grid, an electricity outlet) via an input circuitry or interface such as an electrical cable, whereby the external power source supplies power to power circuitry of the power source 1508. As a further example, the power source 1508 may comprise a source of power in the form of a battery or battery pack which is connected to, or integrated in, power circuitry. The battery may provide backup power should the external power source fail.

Embodiments of the network node 1500 may include additional components beyond those shown in FIG. 15 for providing certain aspects of the network node's functionality, including any of the functionality described herein and/or any functionality necessary to support the subject matter described herein. For example, the network node 1500 may include user interface equipment to allow input of information into the network node 1500 and to allow output of information from the network node 1500. This may allow a user to perform diagnostic, maintenance, repair, and other administrative functions for the network node 1500.

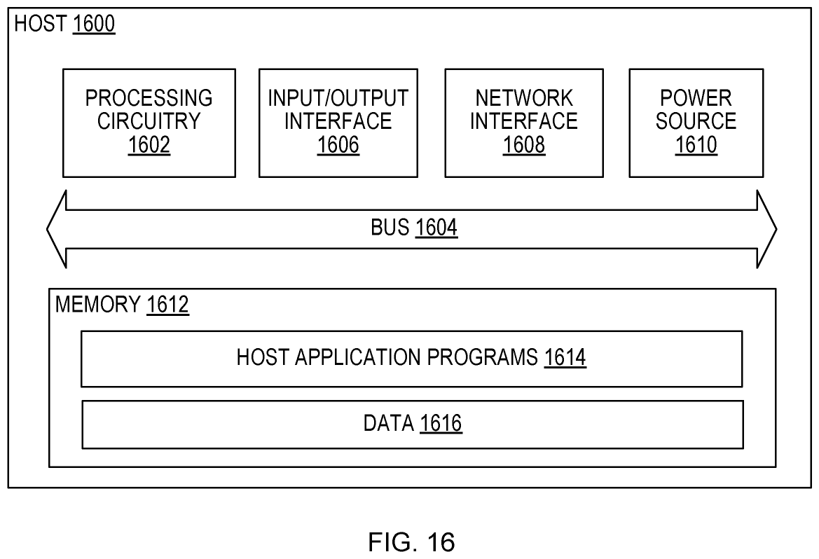

FIG. 16 is a block diagram of a host 1600, which may be an embodiment of the host 1316 of FIG. 13, in accordance with various aspects described herein. As used herein, the host 1600 may be or comprise various combinations hardware and/or software, including a standalone server, a blade server, a cloud-implemented server, a distributed server, a virtual machine, container, or processing resources in a server farm. The host 1600 may provide one or more services to one or more UEs.

The host 1600 includes processing circuitry 1602 that is operatively coupled via a bus 1604 to an input/output interface 1606, a network interface 1608, a power source 1610, and a memory 1612. Other components may be included in other embodiments. Features of these components may be substantially similar to those described with respect to the devices of previous figures, such as FIGS. 14 and 15, such that the descriptions thereof are generally applicable to the corresponding components of host 1600.

The memory 1612 may include one or more computer programs including one or more host application programs 1614 and data 1616, which may include user data, e.g., data generated by a UE for the host 1600 or data generated by the host 1600 for a UE. Embodiments of the host 1600 may utilize only a subset or all of the components shown. The host application programs 1614 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1614 may also provide for user authentication and licensing checks and may periodically report health, routes, and content availability to a central node, such as a device in or on the edge of a core network. Accordingly, the host 1600 may select and/or indicate a different host for over-the-top services for a UE. The host application programs 1614 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

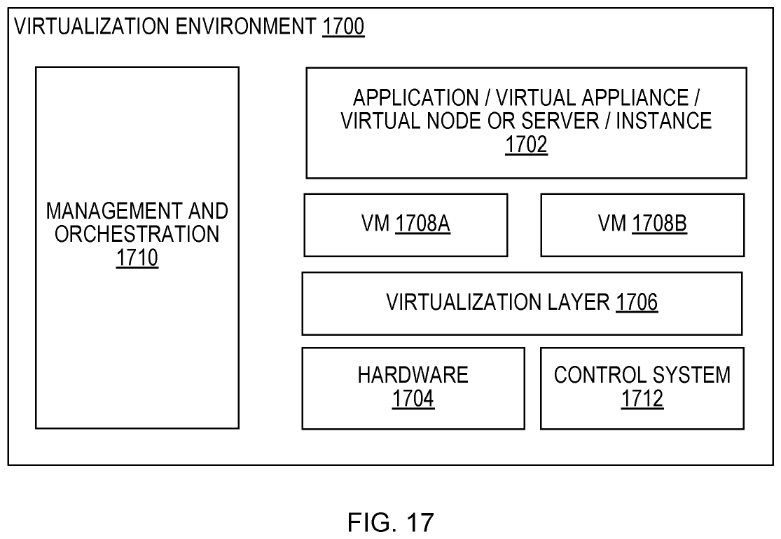

FIG. 17 is a block diagram illustrating a virtualization environment 1700 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1700 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1702 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1704 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1706 (also referred to as hypervisors or virtual machine monitors (VMMs)), provide VMs 1708a and 1708b (one or more of which may be generally referred to as VMs 1708), and/or perform any of the functions, features and/or benefits described in relation with some embodiments described herein. The virtualization layer 1706 may present a virtual operating platform that appears like networking hardware to the VMs 1708.

The VMs 1708 comprise virtual processing, virtual memory, virtual networking or interface and virtual storage, and may be run by a corresponding virtualization layer 1706. Different embodiments of the instance of a virtual appliance 1702 may be implemented on one or more of VMs 1708, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1708 may be a software implementation of a physical machine that runs programs as if they were executing on a physical, non-virtualized machine. Each of the VMs 1708, and that part of hardware 1704 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1708 on top of the hardware 1704 and corresponds to the application 1702.

Hardware 1704 may be implemented in a standalone network node with generic or specific components. Hardware 1704 may implement some functions via virtualization. Alternatively, hardware 1704 may be part of a larger cluster of hardware (e.g. such as in a data center or CPE) where many hardware nodes work together and are managed via management and orchestration 1710, which, among others, oversees lifecycle management of applications 1702. In some embodiments, hardware 1704 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1712 which may alternatively be used for communication between hardware nodes and radio units.

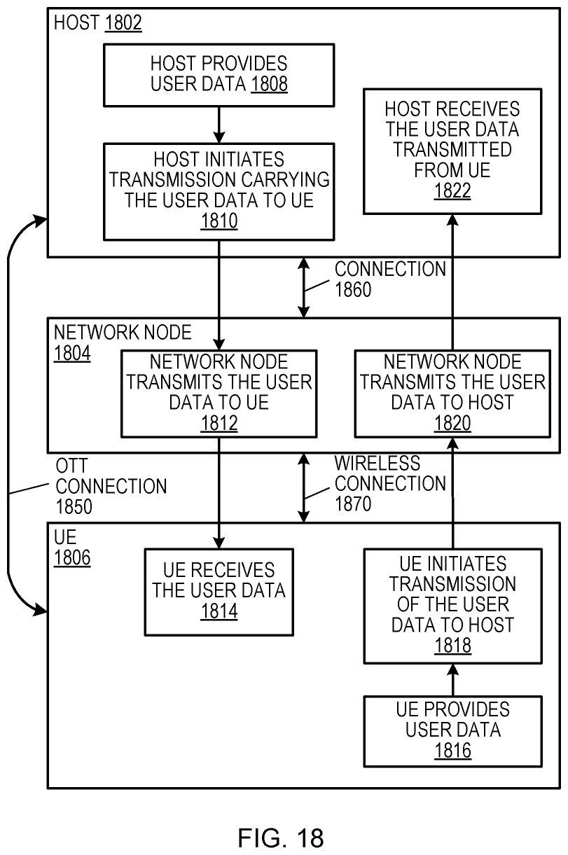

FIG. 18 shows a communication diagram of a host 1802 communicating via a network node 1804 with a UE 1806 over a partially wireless connection in accordance with some embodiments. Example implementations, in accordance with various embodiments, of the UE (such as a UE 1312a of FIG. 13 and/or UE 1400 of FIG. 14), network node (such as network node 1310a of FIG. 13 and/or network node 1500 of FIG. 15), and host (such as host 1316 of FIG. 13 and/or host 1600 of FIG. 16) discussed in the preceding paragraphs will now be described with reference to FIG. 18.

Like host 1600, embodiments of host 1802 include hardware, such as a communication interface, processing circuitry, and memory. The host 1802 also includes software, which is stored in or accessible by the host 1802 and executable by the processing circuitry. The software includes a host application that may be operable to provide a service to a remote user, such as the UE 1806 connecting via an over-the-top (OTT) connection 1850 extending between the UE 1806 and host 1802. In providing the service to the remote user, a host application may provide user data which is transmitted using the OTT connection 1850.

The network node 1804 includes hardware enabling it to communicate with the host 1802 and UE 1806. The connection 1860 may be direct or pass through a core network (like core network 1306 of FIG. 13) and/or one or more other intermediate networks, such as one or more public, private, or hosted networks. For example, an intermediate network may be a backbone network or the Internet.

The UE 1806 includes hardware and software, which is stored in or accessible by UE 1806 and executable by the UE's processing circuitry. The software includes a client application, such as a web browser or operator-specific “app” that may be operable to provide a service to a human or non-human user via UE 1806 with the support of the host 1802. In the host 1802, an executing host application may communicate with the executing client application via the OTT connection 1850 terminating at the UE 1806 and host 1802. In providing the service to the user, the UE's client application may receive request data from the host's host application and provide user data in response to the request data. The OTT connection 1850 may transfer both the request data and the user data. The UE's client application may interact with the user to generate the user data that it provides to the host application through the OTT connection 1850.

The OTT connection 1850 may extend via a connection 1860 between the host 1802 and the network node 1804 and via a wireless connection 1870 between the network node 1804 and the UE 1806 to provide the connection between the host 1802 and the UE 1806. The connection 1860 and wireless connection 1870, over which the OTT connection 1850 may be provided, have been drawn abstractly to illustrate the communication between the host 1802 and the UE 1806 via the network node 1804, without explicit reference to any intermediary devices and the precise routing of messages via these devices.

As an example of transmitting data via the OTT connection 1850, in step 1808, the host 1802 provides user data, which may be performed by executing a host application. In some embodiments, the user data is associated with a particular human user interacting with the UE 1806. In other embodiments, the user data is associated with a UE 1806 that shares data with the host 1802 without explicit human interaction. In step 1810, the host 1802 initiates a transmission carrying the user data towards the UE 1806. The host 1802 may initiate the transmission responsive to a request transmitted by the UE 1806. The request may be caused by human interaction with the UE 1806 or by operation of the client application executing on the UE 1806. The transmission may pass via the network node 1804, in accordance with the teachings of the embodiments described throughout this disclosure. Accordingly, in step 1812, the network node 1804 transmits to the UE 1806 the user data that was carried in the transmission that the host 1802 initiated, in accordance with the teachings of the embodiments described throughout this disclosure. In step 1814, the UE 1806 receives the user data carried in the transmission, which may be performed by a client application executed on the UE 1806 associated with the host application executed by the host 1802.

In some examples, the UE 1806 executes a client application which provides user data to the host 1802. The user data may be provided in reaction or response to the data received from the host 1802. Accordingly, in step 1816, the UE 1806 may provide user data, which may be performed by executing the client application. In providing the user data, the client application may further consider user input received from the user via an input/output interface of the UE 1806. Regardless of the specific manner in which the user data was provided, the UE 1806 initiates, in step 1818, transmission of the user data towards the host 1802 via the network node 1804. In step 1820, in accordance with the teachings of the embodiments described throughout this disclosure, the network node 1804 receives user data from the UE 1806 and initiates transmission of the received user data towards the host 1802. In step 1822, the host 1802 receives the user data carried in the transmission initiated by the UE 1806.

One or more of the various embodiments improve the performance of OTT services provided to the UE 1806 using the OTT connection 1850, in which the wireless connection 1870 forms the last segment. More precisely, the teachings of these embodiments may improve the efficiency of signaling in the network (e.g. by decreasing the amount of signaling in the network) and therefore reduce errors in the network and reduce user waiting time.

In an example scenario, factory status information may be collected and analyzed by the host 1802. As another example, the host 1802 may process audio and video data which may have been retrieved from a UE for use in creating maps. As another example, the host 1802 may collect and analyze real-time data to assist in controlling vehicle congestion (e.g., controlling traffic lights). As another example, the host 1802 may store surveillance video uploaded by a UE. As another example, the host 1802 may store or control access to media content such as video, audio, VR or AR which it can broadcast, multicast or unicast to UEs. As other examples, the host 1802 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1850 between the host 1802 and UE 1806, in response to variations in the measurement results. The measurement procedure and/or the network functionality for reconfiguring the OTT connection may be implemented in software and hardware of the host 1802 and/or UE 1806. In some embodiments, sensors (not shown) may be deployed in or in association with other devices through which the OTT connection 1850 passes; the sensors may participate in the measurement procedure by supplying values of the monitored quantities exemplified above, or supplying values of other physical quantities from which software may compute or estimate the monitored quantities. The reconfiguring of the OTT connection 1850 may include message format, retransmission settings, preferred routing etc.; the reconfiguring need not directly alter the operation of the network node 1804. Such procedures and functionalities may be known and practiced in the art. In certain embodiments, measurements may involve proprietary UE signaling that facilitates measurements of throughput, propagation times, latency and the like, by the host 1802. The measurements may be implemented in that software causes messages to be transmitted, in particular empty or ‘dummy’ messages, using the OTT connection 1850 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

The following paragraphs set out example embodiments of the disclosure.

### Group A Embodiments

1. A method performed by a user equipment, UE, for reconfiguration in a network, the method comprising:
determining a reference configuration for a target candidate configuration associated with a target candidate cell, wherein the target candidate configuration can be applied to the reference configuration to configure the UE for the target candidate cell.

2. The method of any preceding embodiment, wherein the target candidate cell is a target candidate cell of conditional reconfiguration.

3. The method of any preceding embodiment, wherein the reference configuration is the reference configuration for delta signaling of the target candidate configuration.

4. The method of embodiment 4, wherein delta signaling comprises a set of parameter values for a first subset of a set of parameter types and no parameter values for the remaining second subset of the set of parameter types.

5. The method of any preceding embodiment, wherein a reference configuration comprises a set of parameter values for a set of parameter types.

6. The method of embodiment 5, wherein the parameter types correspond to parameters within a reconfiguration message.

7. The method of any preceding embodiment, wherein the method further comprises storing the current configuration of the UE as the reference configuration.

8. The method of any preceding embodiment, wherein the method further comprises receiving an indication to store the current configuration of the UE as the reference configuration.

9. The method of embodiment 8, wherein the indication is received along with instructions for reconfiguration, and wherein the indication indicates that the configuration to be stored is the configuration of the UE before applying the instructions or the configuration of the UE after applying the instructions.

10. The method of any preceding embodiment further comprising applying the target candidate configuration to the determined reference configuration.

11. The method of embodiment 10, wherein the applying further comprises replacing a parameter value of the reference configuration with a parameter value of a delta signaling of the target candidate configuration corresponding to the same parameter type as the parameter value of the reference configuration.

12. The method of embodiment 10 or 11, wherein the method further comprises, before applying the target candidate configuration, reverting the UE's configuration to the reference configuration if the UE's configuration is not the reference condition, then applying the target candidate configuration.

13. The method of embodiment 10 to 12, wherein the target candidate configuration is applied to the determined reference configuration upon fulfilment of an execution condition of the target candidate cell.

14. The method of any preceding embodiment, wherein different target candidate configurations correspond to different reference configurations.

15. The method of any preceding embodiment, wherein the method is performed for at least one target candidate configuration each associated with a target candidate cell, and wherein upon fulfilment of an execution condition for one of the target candidate cells, the method further comprises selecting one of the target candidate cells for which the execution condition is fulfilled, and applying the target candidate configuration of the selected cell to the determined reference configuration.

15a. The method of any preceding embodiment further comprising storing the reference configuration as a default configuration of the UE.

16. The method of any preceding embodiment, further comprising generating a full configuration version for the target candidate cell based on the determined reference configuration and the target candidate configuration, and storing the full configuration version.

17. The method of embodiment 16, wherein the method further comprises applying the generated full configuration version associated with the target candidate configuration upon selection of the corresponding target candidate cell.

18. The method of embodiment 16 or 17, wherein the method further comprises releasing the reference configuration when the full configuration version is generated.

19. The method of any preceding embodiment, wherein the method further comprises receiving from a network node information comprising at least one of: a reference configuration; an indication of a reference configuration; an indication of how to generate a reference configuration; an indication of which configuration amongst a UE source configuration or at least one UE target candidate configuration is the reference configuration; an indication that the current UE configuration can be used as the reference configuration.

20. The method of embodiment 19, wherein the information is received as part of a conditional cell change operation.

21. The method of any preceding embodiment, wherein the determining is performed by receiving an indication of the reference configuration associated with the target candidate cell and/or selecting an indication of the reference configuration associated with the target candidate cell.

22. The method of any preceding embodiment, wherein the UE is operating in Multi-Radio Dual Connectivity, MR-DC.

23. The method of embodiment 22, wherein the reference configuration comprises at least one of: a master cell part corresponding to a master cell group; a secondary cell part corresponding to a secondary cell group.

24. The method of embodiment 22 or 23, wherein the reference configuration comprises at least one of: a master cell reference configuration corresponding to a master cell group; a secondary cell reference configuration corresponding to a secondary cell group.

25. The method of embodiment 22 to 24, wherein the method further comprises receiving a reconfiguration message comprising one or more target candidate configurations from a network node.

26. The method of embodiment 25, wherein the method further comprises determining the reference configuration to be a configuration comprised in the reconfiguration message.

27. The method of embodiment 25 or 26, wherein the network node is a master node.

28. The method of embodiment 25 to 27, wherein the reconfiguration message is an RRC reconfiguration message.

29. The method of embodiment 25 to 28, wherein the determining the reference configuration of the target candidate configuration is performed upon reception of the reconfiguration message.

30. The method of any preceding embodiment, wherein the reference configuration comprises a current UE configuration.

31. The method of embodiment 30, wherein the current UE configuration is a configuration used by the UE for communication with the network.

32. The method of embodiment 30 or 31, wherein the current UE reference configuration comprises the configuration with which the UE is operating when it receives a reconfiguration message.

33. The method of embodiment 30 to 32, wherein the method further comprises receiving the current UE reference configuration or an indication of the current reference configuration, and storing the current UE reference configuration.

34. The method of embodiment 30 to 33, wherein the current UE reference configuration comprises the configuration with which the UE was operating before applying the target candidate configuration to the determined reference configuration or after applying the target candidate configuration to the determined reference configuration.

35. The method of any preceding embodiment, wherein the method further comprises determining that the reference configuration is the configuration of a target candidate for which the UE has been configured.

36. The method of any preceding embodiment, further comprising receiving an indication of which configuration of a plurality of target candidate configurations is the reference configuration.

37. The method of embodiment 36, wherein the target candidate configuration indicated to be the reference configuration is a full configuration.

38. The method of embodiment 36 or 37, wherein the target candidate configuration indicated to be the reference configuration is a delta signaling, and where the method further comprises generating a full configuration version as the reference configuration based on the delta signaling

39. The method of embodiment 38, wherein the target candidate configuration indicated to be the reference for a delta signaling is a delta signaling on top of another reference configuration, and where the delta signaling is stored separately to the another reference configuration.

40. The method of any preceding embodiment, wherein different target candidate configurations have different reference configurations, and wherein the method further comprises storing the different target candidate configurations and the corresponding different reference configurations.

41. The method of any preceding embodiment, wherein a subset of target candidate configurations have a first reference configuration, and another subset of target candidate configurations have a second reference configuration.

42. The method of any preceding embodiment, wherein the method further comprises determining if the reference configuration is a configuration related to the occurrence of a predefined event.

43. The method of embodiment 42, wherein the method further comprises storing the reference configuration when it is determined that the reference configuration relates to the occurrence of a predefined event.

44. The method of embodiment 42 or 43, wherein the reference configuration is the resulting configuration of the UE after receiving and applying a reconfiguration message when the UE transitions from an idle state to a connected state.

45. The method of embodiment 42 to 44, wherein the reference configuration is the resulting configuration of the UE after receiving and applying a reconfiguration message after the reception of a resume message.

46. The method of embodiment 42 to 45, wherein if the UE transitions from an inactive state to a connected state, the reference configuration is the resulting configuration of the UE after receiving and applying a resume message.

47. The method of embodiment 42 to 46, wherein if the UE transitions from an inactive state to a connected state, the reference configuration is the resulting configuration of the UE after receiving and applying the first reconfiguration message after the reception of the resume message.

48. The method of embodiment 42 to 47, wherein the event is at least one of: the first RRC Reconfiguration after re-establishment; a reconfiguration with synchronization.

49. The method according to any preceding embodiment, the method further comprising storing the reference configuration for one connection type when switching to another connection type.

50. The method according to any preceding embodiment, further comprising receiving an indication of which reference configuration to keep when the UE resumes a connection.

51. The method according to any preceding embodiment, wherein the reference configuration is a complete configuration comprising all parameters of the UE configuration, or is a part configuration.

52. The method according to embodiment 51, wherein if the reference configuration is a part configuration, the method further comprises receiving an indication of values of the parameters that are not part of the reference configuration.

53. The method according to any preceding embodiment, wherein the method further comprises receiving an indication to apply the reference configuration and then to apply a delta signaling of the target candidate configuration.

54. The method according to embodiment 53, wherein the indication to apply the reference configuration and the delta signaling is at least one of: indicated explicitly; indicated explicitly; standardized.

55. The method according to embodiment 54, wherein the indication to apply the reference configuration and the delta signaling comprises an indication to apply a specific reference configuration.

56. The method according to any preceding embodiment, wherein the method further comprises transmitting a response message indicating that the configuration is successful.

57. The method of any of the previous embodiments, further comprising:
providing user data; and
forwarding the user data to a host via the transmission to the network node.

### Group B Embodiments

58. A method performed by a network node for reconfiguration in a network, the method comprising:
signaling to a UE or a network node at least one of: a reference configuration for a target candidate configuration associated with a target candidate cell; an indication of a reference configuration for a target candidate configuration associated with a target candidate cell; an indication of how to generate a reference configuration for a target candidate configuration associated with a target candidate cell, wherein the target candidate configuration can be applied to the reference configuration to configure the UE for the target candidate cell.

59. The method of embodiment 58, wherein the method further comprises determining the reference configuration.

60. A method performed by a first network node for reconfiguration in a network, the method comprising:
for a network operating with Multi-Radio Dual Connectivity, MR-DC, indicating to a second network node that a current secondary cell group configuration may be used as a reference configuration for a target candidate configuration associated with a target candidate cell, wherein the target candidate configuration can be applied to the reference configuration to configure the UE for the target candidate cell; or
signaling to the second network node a reference configuration or indicating a reference configuration for a target candidate configuration associated with a target candidate cell, wherein the target candidate configuration can be applied to the reference configuration to configure the UE for the target candidate cell.

61. The method of embodiment 60, the method further comprising:
determining that a conditional cell change is to be configured; and
transmitting to the second network node a request for conditional cell change, comprising conditional cell change candidates and current secondary cell group configuration.

62. The method of embodiment 60 or 61, wherein the first network node is a source secondary node, S-SN.

63. The method of embodiment 60 to 62, wherein the second network node is a master node.

64. A method performed by a second network node for reconfiguration in a network, the method comprising:
transmitting to a UE information for a UE to determine a reference configuration for a target candidate configuration associated with a target candidate cell, wherein the target candidate configuration can be applied to the reference configuration to configure the UE for the target candidate cell.

65. The method of embodiment 64, wherein the second network node is a master node.

66. The method of embodiment 64 or 65, wherein the information is comprised in a reconfiguration message.

67. The method of embodiment 64 to 66 further comprising, prior to the transmitting, receiving from a third network node at least one of: a target secondary cell group configuration; a reference configuration for a target candidate configuration associated with a target candidate cell, wherein the target candidate configuration can be applied to the reference configuration to configure the UE for the target candidate cell; an indication of a reference configuration for a target candidate configuration associated with a target candidate cell, wherein the target candidate configuration can be applied to the reference configuration to configure the UE for the target candidate cell.

68. The method of embodiment 64 to 67, the method further comprising:
receiving a request for conditional cell change, comprising conditional cell change candidates and current conditional cell change confirmation;
transmitting, to a third network node, a request message for conditional cell change, the message comprising the conditional cell change candidate and the current conditional cell change configuration; or transmitting, to the third network node, a reference configuration or the current secondary cell group configuration and the reference configurations.

69. The method of embodiment 64 to 68, wherein the reference configuration comprises at least one of: a secondary cell group configuration; a master cell group and a secondary cell group configuration; a master cell group configuration.

70. The method of embodiment 64 to 69, wherein the reference configuration is determined to be the reference configuration indicated by the network.

71. The method of embodiment 64 to 71, wherein the method further comprises signaling an indication of which configuration amongst a UE source configuration or at least one UE target candidate configuration is the reference configuration.

72. The method of embodiment 64 to 71, wherein the information is sent separately to, together with, or as a part of a reconfiguration message.

73. The method of embodiment 64 to 72, wherein the information comprises the identity of a configuration that is the reference configuration.

74. The method of embodiment 64 to 73, wherein the method further comprises receiving a response message from the UE indicating successful configuration.

75. The method of embodiment 64 to 74, wherein the method further comprises receiving a response message from the UE indication the successful execution of conditional cell change.

76. The method of embodiment 64 to 75, wherein the method further comprises transmitting to a third network node an indication that the UE has executed conditional cell change and to which cell the UE executed the conditional cell change.

77. The method of embodiment 64 to 76, wherein the method further comprises transmitting a message to the UE with an update of the conditional cell change configuration and/or a reference configuration.

78. A method in a third network node for reconfiguration in a network, the method comprising:
transmitting to a second network node at least one of: a target secondary cell group configuration for conditional cell change; a reference configuration for a target candidate configuration associated with a target candidate cell, wherein the target candidate configuration can be applied to the reference configuration to configure the UE for the target candidate cell; an indication of a reference configuration for a target candidate configuration associated with a target candidate cell, wherein the target candidate configuration can be applied to the reference configuration to configure the UE for the target candidate cell.

79. The method of embodiment 78, wherein the method further comprises, prior to the transmitting, receiving, from the second network node, a request message for conditional cell change, the message comprising at least one of: the conditional cell change candidates and the current secondary cell group configuration; a reference configuration, or the current secondary cell group configuration and the reference configuration.

80. The method of embodiment 78 or 79, wherein the reference configuration comprises a secondary cell group configuration, or a master cell group configuration and a secondary cell group configuration, or a master cell group configuration.

81. The method of embodiment 78 to 80, wherein the method further comprises determining whether to define a reference configuration for a UE to use.

82. The method of embodiment 78 to 81, wherein the method further comprises receiving from the second network node a message containing information that the UE has executed conditional cell change and for which cell the UE has executed the conditional cell change.

83. The method of embodiment 58 to 81, wherein the third network node is a target candidate secondary node.

84. The method of any of embodiments 58 to 81, wherein the UE is the UE of the Group A embodiments.

85. The method of any of the previous embodiments, further comprising:
obtaining user data; and
forwarding the user data to a host or a user equipment.

### Group C Embodiments

86. A user equipment for reconfiguration in a network, comprising:
processing circuitry configured to cause the user equipment to perform any of the steps of any of the Group A embodiments; and
power supply circuitry configured to supply power to the processing circuitry.

87. A network node for reconfiguration in a network, the network node comprising:
processing circuitry configured to cause the network node to perform any of the steps of any of the Group B embodiments;
power supply circuitry configured to supply power to the processing circuitry.

88. A user equipment (UE) for reconfiguration in a network, the UE comprising:
an antenna configured to send and receive wireless signals;
radio front-end circuitry connected to the antenna and to processing circuitry, and configured to condition signals communicated between the antenna and the processing circuitry;
the processing circuitry being configured to perform any of the steps of any of the Group A embodiments;
an input interface connected to the processing circuitry and configured to allow input of information into the UE to be processed by the processing circuitry;
an output interface connected to the processing circuitry and configured to output information from the UE that has been processed by the processing circuitry; and
a battery connected to the processing circuitry and configured to supply power to the UE.

89. A host configured to operate in a communication system to provide an over-the-top (OTT) service, the host comprising:
processing circuitry configured to provide user data; and
a network interface configured to initiate transmission of the user data to a cellular network for transmission to a user equipment (UE),
wherein the UE comprises a communication interface and processing circuitry, the communication interface and processing circuitry of the UE being configured to perform any of the steps of any of the Group A embodiments to receive the user data from the host.

90. The host of the previous embodiment, wherein the cellular network further includes a network node configured to communicate with the UE to transmit the user data to the UE from the host.

91. The host of the previous 2 embodiments, wherein:
the processing circuitry of the host is configured to execute a host application, thereby providing the user data; and
the host application is configured to interact with a client application executing on the UE, the client application being associated with the host application.

92. A method implemented by a host operating in a communication system that further
includes a network node and a user equipment (UE), the method comprising: providing user data for the UE; and
initiating a transmission carrying the user data to the UE via a cellular network comprising the network node, wherein the UE performs any of the operations of any of the Group A embodiments to receive the user data from the host.

93. The method of the previous embodiment, further comprising:
at the host, executing a host application associated with a client application executing on the UE to receive the user data from the UE.

94. The method of the previous embodiment, further comprising:
at the host, transmitting input data to the client application executing on the UE, the input data being provided by executing the host application,
wherein the user data is provided by the client application in response to the input data from the host application.

95. A host configured to operate in a communication system to provide an over-the-top (OTT) service, the host comprising:
processing circuitry configured to provide user data; and
a network interface configured to initiate transmission of the user data to a cellular network for transmission to a user equipment (UE),
wherein the UE comprises a communication interface and processing circuitry, the communication interface and processing circuitry of the UE being configured to perform any of the steps of any of the Group A embodiments to transmit the user data to the host.

96. The host of the previous embodiment, wherein the cellular network further includes a network node configured to communicate with the UE to transmit the user data from the UE to the host.

97. The host of the previous 2 embodiments, wherein:
the processing circuitry of the host is configured to execute a host application, thereby providing the user data; and
the host application is configured to interact with a client application executing on the UE, the client application being associated with the host application.

98. A method implemented by a host configured to operate in a communication system that
further includes a network node and a user equipment (UE), the method comprising: at the host, receiving user data transmitted to the host via the network node by the UE, wherein the UE performs any of the steps of any of the Group A embodiments to transmit the user data to the host.

99. The method of the previous embodiment, further comprising:
at the host, executing a host application associated with a client application executing on the UE to receive the user data from the UE.

100. The method of the previous embodiment, further comprising:
at the host, transmitting input data to the client application executing on the UE, the input data being provided by executing the host application,
wherein the user data is provided by the client application in response to the input data from the host application.

101. A host configured to operate in a communication system to provide an over-the-top (OTT) service, the host comprising:
processing circuitry configured to provide user data; and
a network interface configured to initiate transmission of the user data to a network node in a cellular network for transmission to a user equipment (UE), the network node having a communication interface and processing circuitry, the processing circuitry of the network node configured to perform any of the operations of any of the Group B embodiments to transmit the user data from the host to the UE.

102. The host of the previous embodiment, wherein:
the processing circuitry of the host is configured to execute a host application that provides the user data; and
the UE comprises processing circuitry configured to execute a client application associated with the host application to receive the transmission of user data from the host.

103. A method implemented in a host configured to operate in a communication system that further includes a network node and a user equipment (UE), the method comprising:
providing user data for the UE; and
initiating a transmission carrying the user data to the UE via a cellular network comprising the network node, wherein the network node performs any of the operations of any of the Group B embodiments to transmit the user data from the host to the UE.

104. The method of the previous embodiment, further comprising, at the network node, transmitting the user data provided by the host for the UE.

105. The method of any of the previous 2 embodiments, wherein the user data is provided at the host by executing a host application that interacts with a client application executing on the UE, the client application being associated with the host application.

106. A communication system configured to provide an over-the-top service, the communication system comprising:
a host comprising:
processing circuitry configured to provide user data for a user equipment (UE), the user data being associated with the over-the-top service; and
a network interface configured to initiate transmission of the user data toward a cellular network node for transmission to the UE, the network node having a communication interface and processing circuitry, the processing circuitry of the network node configured to perform any of the operations of any of the Group B embodiments to transmit the user data from the host to the UE.

107. The communication system of the previous embodiment, further comprising:
the network node; and/or
the user equipment.

108. A host configured to operate in a communication system to provide an over-the-top (OTT) service, the host comprising:
processing circuitry configured to initiate receipt of user data; and a network interface configured to receive the user data from a network node in a cellular
network, the network node having a communication interface and processing circuitry, the processing circuitry of the network node configured to perform any of the operations of any of the Group B embodiments to receive the user data from a user equipment (UE) for the host.

109. The host of the previous embodiment, wherein:
the processing circuitry of the host is configured to execute a host application, thereby providing the user data; and
the host application is configured to interact with a client application executing on the UE, the client application being associated with the host application.

110. The host of the any of the previous 2 embodiments, wherein the initiating receipt of the user data comprises requesting the user data.

111. A method implemented by a host configured to operate in a communication system that further includes a network node and a user equipment (UE), the method comprising:
at the host, initiating receipt of user data from the UE, the user data originating from a transmission which the network node has received from the UE, wherein the network node performs any of the steps of any of the Group B embodiments to receive the user data from the UE for the host.

112. The method of the previous embodiment, further comprising at the network node, transmitting the received user data to the host.

### ABBREVIATIONS

At least some of the following abbreviations may be used in this disclosure. If there is an inconsistency between abbreviations, preference should be given to how it is used above. If listed multiple times below, the first listing should be preferred over any subsequent listing(s).

| Abbreviation | Explanation |
|---|---|
| 5GC or 5GCN | 5G core network |
| ACK | Acknowledgement |
| AGC | Automatic Gain Control |
| AMF | Access and Mobility management Function |
| AP | Application Protocol |
| BSR | Buffer Status Report |
| BWP | Bandwidth Part |
| C-RNTI | Cell Radio Network Temporary Identifier |
| CA | Carrier Aggregation |
| CE | Control Element |
| CHO | Conditional Handover |
| CN | Core Network |
| CPA | Conditional PSCell Addition |
| CPC | Conditional PSCell Change |
| CP | Control Plane |
| CQI | Channel Quality Indicator |
| C-RNTI | Cell Radio Network Temporary Identifier |
| CSI | Channel State Information |
| DC | Dual Connectivity |
| DCI | Downlink Control Information |
| DL | Downlink |
| DRB | Data Radio Bearer |
| eNB | (EUTRAN) base station |
| E-RAB | EUTRAN Radio Access Bearer |
| E-UTRA | Evolved Universal Terrestrial Radio Access |
| E-UTRAN | Evolved Universal Terrestrial Radio Access Network |
| FDD | Frequency Division Duplex |
| gNB | NR base station |
| GTP-U | GPRS Tunneling Protocol - User Plane |
| IE | Information Element |
| IP | Internet Protocol |
| LTE | Long Term Evolution |
| MCG | Master Cell Group |
| MAC | Medium Access Control |
| MAC CE | MAC Control Element |
| MeNB | Master eNB |
| MgNB | Master gNB |
| MN | Master Node |
| MR-DC | Multi-Radio Dual Connectivity |
| NACK | Negative Acknowledgement |
| NAS | Non Access Stratum |
| NG-RAN | Next Generation Radio Access Network |
| Ng-eNB | Next Generation Evolved Node B |
| NR | New Radio |
| PDCP | Packet Data Convergence Protocol |
| PCell | Primary Cell |
| PCI | Physical Cell Identity |
| PDCCH | Physical Downlink Control Channel |
| PHR | Power headroom report |
| PSCell | Primary Secondary Cell (in LTE) or Primary SCG Cell (in NR) |
| PUCCH | Physical Uplink Control Channel |
| PUSCH | Phyical Uplink Shared Channel |
| RACH | Random Access Channel |
| RAT | Radio Access Technology |
| RB | Radio Bearer |
| RLC | Radio Link Control |
| RLF | Radio Link Failure |
| RRC | Radio Resource Control |
| SCell | Secondary Cell |
| SCG | Secondary Cell Group |
| SCTP | Stream Control Transmission Protocol |
| SeNB | Secondary eNB |
| SgNB | Secondary gNB |
| SINR | Signal to Interference plus Noise Ratio |
| SN | Secondary Node |
| SR | Scheduling Request |
| SRB | Signaling Radio Bearer |
| S-SN | Source Secondary Node |
| SUL | Supplementary uplink |
| SpCell | Special Cell, the primary cell of a master or secondary cell group |
| TAT | Time Alignment Timer |
| TDD | Time Division Duplex |
| TEID | Tunnel Endpoint IDentifier |
| TNL | Transport Network Layer |
| T-SN | Target Secondary Node |
| UCI | Uplink Control Information |
| UDP | User Datagram Protocol |
| UPF | User Plane Function |
| UE | User Equipment |
| UL | Uplink |
| UL-SCH | Uplink Shared Channel |
| UP | User Plane |
| URLLC | Ultra Reliable Low Latency Communication |
| X2 | Interface between base stations |
| 1x RTT CDMA2000 | 1x Radio Transmission Technology |
| 3GPP | 3rd Generation Partnership Project |
| 5G | 5th Generation |
| 6G | 6th Generation |
| ABS | Almost Blank Subframe |
| ARQ | Automatic Repeat Request |
| AWGN | Additive White Gaussian Noise |
| BCCH | Broadcast Control Channel |
| BCH | Broadcast Channel |
| CA | Carrier Aggregation |
| CC | Carrier Component |
| CCCH SDU | Common Control Channel SDU |
| CDMA | Code Division Multiplexing Access |
| CGI | Cell Global Identifier |
| CIR | Channel Impulse Response |
| CP | Cyclic Prefix |
| CPICH | Common Pilot Channel |
| CPICH | Ec/No CPICH Received energy per chip divided by the power density in the band |
| CQI | Channel Quality information |
| C-RNTI | Cell RNTI |
| CSI | Channel State Information |
| DCCH | Dedicated Control Channel |
| DL | Downlink |
| DM | Demodulation |
| DMRS | Demodulation Reference Signal |
| DRX | Discontinuous Reception |
| DTX | Discontinuous Transmission |
| DTCH | Dedicated Traffic Channel |
| DUT | Device Under Test |
| E-CID | Enhanced Cell-ID (positioning method) |
| eMBMS | evolved Multimedia Broadcast Multicast Services |
| E-SMLC | Evolved-Serving Mobile Location Centre |
| ECGI | Evolved CGI |
| eNB | E-UTRAN NodeB |
| ePDCCH | Enhanced Physical Downlink Control Channel |
| E-SMLC | Evolved Serving Mobile Location Center |
| E-UTRA | Evolved UTRA |
| E-UTRAN | Evolved UTRAN |
| FDD | Frequency Division Duplex |
| FFS | For Further Study |
| gNB | Base station in NR |
| GNSS | Global Navigation Satellite System |
| HARQ | Hybrid Automatic Repeat Request |
| HO | Handover |
| HSPA | High Speed Packet Access |
| HRPD | High Rate Packet Data |
| LOS | Line of Sight |
| LPP | LTE Positioning Protocol |
| LTE | Long-Term Evolution |
| MAC | Medium Access Control |
| MAC | Message Authentication Code |
| MBSFN | Multimedia Broadcast multicast service Single Frequency Network |
| MBSFN | ABS MBSFN Almost Blank Subframe |
| MDT | Minimization of Drive Tests |
| MIB | Master Information Block |
| MME | Mobility Management Entity |
| MSC | Mobile Switching Center |
| NPDCCH | Narrowband Physical Downlink Control Channel |
| NR | New Radio |
| OCNG OFDMA | Channel Noise Generator |
| OFDM | Orthogonal Frequency Division Multiplexing |
| OFDMA | Orthogonal Frequency Division Multiple Access |
| OSS | Operations Support System |
| OTDOA | Observed Time Difference of Arrival |
| O&M | Operation and Maintenance |
| PBCH | Physical Broadcast Channel |
| P-CCPCH | Primary Common Control Physical Channel |
| PCell | Primary Cell |
| PCFICH | Physical Control Format Indicator Channel |
| PDCCH | Physical Downlink Control Channel |
| PDCP | Packet Data Convergence Protocol |
| PDP | Profile Delay Profile |
| PDSCH | Physical Downlink Shared Channel |
| PGW | Packet Gateway |
| PHICH | Physical Hybrid-ARQ Indicator Channel |
| PLMN | Public Land Mobile Network |
| PMI | Precoder Matrix Indicator |
| PRACH | Physical Random Access Channel |
| PRS | Positioning Reference Signal |
| PSS | Primary Synchronization Signal |
| PUCCH | Physical Uplink Control Channel |
| PUSCH | Physical Uplink Shared Channel |
| RACH | Random Access Channel |
| QAM | Quadrature Amplitude Modulation |
| RAN | Radio Access Network |
| RAT | Radio Access Technology |
| RLC | Radio Link Control |
| RLM | Radio Link Management |
| RNC | Radio Network Controller |
| RNTI | Radio Network Temporary Identifier |
| RRC | Radio Resource Control |
| RRM | Radio Resource Management |
| RS | Reference Signal |
| RSCP | Received Signal Code Power |
| RSRP | Reference Symbol Received Power OR Reference Signal Received Power |
| RSRQ | Reference Signal Received Quality OR Reference Symbol Received Quality |
| RSSI | Received Signal Strength Indicator |
| RSTD | Reference Signal Time Difference |
| SCH | Synchronization Channel |
| SCell | Secondary Cell |
| SDAP | Service Data Adaptation Protocol |
| SDU | Service Data Unit |
| SFN | System Frame Number |
| SGW | Serving Gateway |
| SI | System Information |
| SIB | System Information Block |
| SNR | Signal to Noise Ratio |
| SON | Self Optimized Network |
| SS | Synchronization Signal |
| SSS | Secondary Synchronization Signal |
| TDD | Time Division Duplex |
| TDOA | Time Difference of Arrival |
| TOA | Time of Arrival |
| TSS | Tertiary Synchronization Signal |
| TTI | Transmission Time Interval |
| UE | User Equipment |
| UL | Uplink |
| USIM | Universal Subscriber Identity Module |
| UTDOA | Uplink Time Difference of Arrival |
| WCDMA | Wide CDMA |
| WLAN | Wide Local Area Network |

1-51. (canceled)

52. A method performed by a user equipment (UE), the method comprising
receiving an RRC reconfiguration message including a first target candidate cell configuration (RRCReconfiguration B) for conditional PSCell change (CPC) and a second target candidate cell configuration for CPC, (RRCReconfiguration C);
while operating in a source cell (PSCell A), executing CPC to a first target cell (PSCell B) by applying the first target candidate cell configuration (RRCReconfiguration B), and keeping the second target candidate cell configuration for CPC, (RRCReconfiguration C) stored; and
while operating in the first target cell (PSCell B), executing CPC to the second target cell (PSCell C) by applying the second target candidate cell configuration for CPC, (RRCReconfiguration C) as a delta configuration to a reference configuration for generating a full configuration version for the second target candidate cell (PSCell C), wherein the reference configuration is determined by receiving an explicitly signalled reference configuration from a network node.

53. The method of claim 52, wherein generating the full configuration version comprises applying the delta configuration on top of the reference configuration.

54. The method of claim 52, wherein different target candidate configurations correspond to different reference configurations.

55. The method of claim 52, wherein the UE is operating in Multi-Radio Dual Connectivity (MR-DC).

56. The method of claim 52, wherein the network node is a master node.

57. The method of claim 52, wherein determining the reference configuration of the target candidate configuration is performed upon reception of the reconfiguration message.

58. The method of claim 52, wherein a subset of target candidate configurations has a first reference configuration, and another subset of target candidate configurations has a second reference configuration.

59. A user equipment (UE) comprising:
a communication interface; and
processing circuitry configured to:
receive, via the communication interface, an RRC reconfiguration message including a first target candidate cell configuration (RRCReconfiguration B) for conditional PSCell change (CPC) and a second target candidate cell configuration for CPC, (RRCReconfiguration C);
with respect to the UE operating in a source cell (PSCell A), cause the UE to execute CPC to a first target cell (PSCell B), by applying the first target candidate cell configuration (RRCReconfiguration B), and keep the second target candidate cell configuration for CPC, (RRCReconfiguration C) stored; and
with respect to the UE operating in the first target cell (PSCell B), cause the UE execute CPC to the second target cell (PSCell C), by applying the second target candidate cell configuration for CPC, (RRCReconfiguration C) as a delta configuration to a reference configuration for generating a full configuration version for the second target candidate cell (PSCell C), wherein the reference configuration is determined by receiving an explicitly signalled reference configuration from a network node.
